(19) United States
(12) Patent Application Publication
(10) Pub. No.: US 2010/0085512 A1
(43) Pub. Date: Apr. 8, 2010

(54) SURFACE LIGHT SOURCE DEVICE AND LIQUID CRYSTAL DISPLAY DEVICE ASSEMBLY

(75) Inventors: Mitsunori Ueda, Tokyo (JP); Kanji Yokomizo, Kanagawa (JP); Mariko Obinata, Kanagawa (JP); Yuichi Miyagawa, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/571,810

(22) Filed: Oct. 1, 2009

(30) Foreign Application Priority Data
Oct. 2, 2008 (JP) P2008257134

(51) Int. Cl. G02F 1/13357

(52) U.S. Cl. 349/68; 362/97.3

(57) ABSTRACT

Disclosed herein is a surface light source device that illuminates a transmissive liquid crystal display device having a display area formed of pixels arranged in a two-dimensional matrix from a back side of the liquid crystal display device, the surface light source device comprising a plurality of light emitting element units, wherein each of the light emitting element units includes: at least one first light emitting element assembly; at least one second light emitting element assembly; and at least one third light emitting element assembly, and focal length and lateral magnification of each of the first lens, the second lens, and the third lens are adjusted based on emission intensity distribution of each of the first light emitting element, the second light emitting element, and the third light emitting element.

### CROSS REFERENCES TO RELATED APPLICATIONS

The present application claims priority to Japanese Priority Patent Application JP 2008-257134 filed in the Japan Patent Office on Oct. 2, 2008, the entire content of which is hereby incorporated by reference.

### BACKGROUND

The present application relates to a surface light source device and a liquid crystal display device assembly.

In a liquid crystal display device, the liquid crystal material does not emit light. Therefore, e.g. a direct-lit surface light source device (backlight) for illuminating the display area of the liquid crystal display device is disposed on the back side of the display area formed of plural pixels. In a color liquid crystal display device, one pixel is composed of e.g. three kinds of sub-pixels: a red light emitting sub-pixel, a green light emitting sub-pixel, and a blue light emitting sub-pixel. An image is displayed by operating the liquid cell of each sub-pixel as a kind of optical shutter (light valve), i.e. by controlling the light transmission (aperture ratio) of each sub-pixel to thereby control the light transmission of illuminating light (e.g. white light) emitted from the surface light source device.

In a related art, a surface light source device in a liquid crystal display device assembly illuminates the entire display area with uniform, constant luminance. A configuration different from that of such a surface light source device is known from e.g. Japanese Patent Laid-open No. 2005-258403. Specifically, this patent document discloses a surface light source device that is formed of plural surface light source units and has a configuration for varying the distribution of the illuminance of plural display area units (surface light source device of a partial driving system or a division driving system). By control of such a surface light source device (referred to also as partial driving or division driving of the surface light source device), increase in the contrast ratio due to increase in the white level and the lowering of the black level in the liquid crystal display device can be achieved. As a result, the quality of image displaying can be enhanced and the power consumption of the surface light source device can be reduced.

The light source of each surface light source unit in the surface light source device is often composed of a red light emitting diode, a green light emitting diode, and a blue light emitting diode. Red light, green light, and blue light obtained by the light emission of these light emitting diodes are mixed with each other to thereby obtain white light, and the display area of the liquid crystal display device is illuminated by this white light.

### SUMMARY

It is necessary to sufficiently suppress color unevenness of the white light as the illuminating light emitted from the surface light source unit in this manner. To this end, the emission intensity distributions of the red light emitting diode, the green light emitting diode, and the blue light emitting diode of each surface light source unit need to be made identical to each other. The reason for this is as follows. For example, if the emission intensity distribution of a light emitting diode that emits light of a certain color has a wider spread compared with the emission intensity distributions of the light emitting diodes that emit light of the other colors, the color from the light emitting diode that emits light of the certain color is recognized more intensely at the edge of the spatial area of the light mixing when light beams emitted from these three kinds of light emitting diodes are mixed with each other. This results in the occurrence of color unevenness.

However, in general, the emission intensity distribution of the light emitting diode differs if the type, size, and so on of the light emitting diode are different. Therefore, in practice, it is very difficult that the emission intensity distributions of the red light emitting diode, the green light emitting diode, and the blue light emitting diode are made identical to each other. On the other hand, if the light emitting diodes are so selected that the emission intensity distributions thereof are identical to each other, the design flexibility is lowered and the manufacturing cost of the surface light source device is increased.

There is a need to provide a surface light source device having such configuration and structure as to hardly cause color unevenness even if the emission intensity distributions of light emitting elements that emit light beams of three primary colors of light are different from each other, and a liquid crystal display device assembly including this surface light source device.

According to a first embodiment and a second embodiment, there are provided surface light source devices that each illuminate a transmissive liquid crystal display device having a display area formed of pixels arranged in a two-dimensional matrix from the back side of the liquid crystal display device.

Furthermore, according to the first embodiment and the second embodiment, there are provided liquid crystal display device assemblies each including

(1) a transmissive liquid crystal display device configured to have a display area formed of pixels arranged in a two-dimensional matrix, and

(2) a surface light source device configured to illuminate the liquid crystal display device from the back side of the liquid crystal display device.

The surface light source device according to the first embodiment of the present invention and the surface light source device in the liquid crystal display device assembly according to the first embodiment of the present invention each include a plurality of light emitting element units.

Each of the light emitting element units includes

(A) at least one first light emitting element assembly that is formed of a first light emitting element and a first lens and emits, via the first lens, first primary color light corresponding to a first primary color of three primary colors of light, composed of the first primary color, a second primary color, and a third primary color,

(B) at least one second light emitting element assembly that is formed of a second light emitting element and a second lens and emits second primary color light corresponding to the second primary color via the second lens, and

(C) at least one third light emitting element assembly that is formed of a third light emitting element and a third lens and emits third primary color light corresponding to the third primary color via the third lens.

The focal length and lateral magnification of each of the first lens, the second lens, and the third lens are adjusted based on the emission intensity distribution of each of the first light emitting element, the second light emitting element, and the third light emitting element.

The surface light source device according to the second embodiment of the present invention and the surface light source device in the liquid crystal display device assembly according to the second embodiment of the present invention each include P×Q surface light source units configured to be independently controlled regarding driving and correspond to P×Q virtual display area units defined based on the assumption that the display area of the liquid crystal display device is divided into the P×Q display area units.

A light diffuser is disposed above the P×Q surface light source units, and each of the surface light source units includes at least one light emitting element unit.

Each light emitting element unit includes

(A) at least one first light emitting element assembly that is formed of a first light emitting element and a first lens and emits, via the first lens, first primary color light corresponding to a first primary color of three primary colors of light, composed of the first primary color, a second primary color, and a third primary color,

(B) at least one second light emitting element assembly that is formed of a second light emitting element and a second lens and emits second primary color light corresponding to the second primary color via the second lens, and

(C) at least one third light emitting element assembly that is formed of a third light emitting element and a third lens and emits third primary color light corresponding to the third primary color via the third lens.

The focal length of each of the first lens, the second lens, and the third lens is adjusted based on the light intensity distributions on the light diffuser, of light beams emitted from the first light emitting element, the second light emitting element, and the third light emitting element.

In the surface light source device according to the first embodiment and the surface light source device in the liquid crystal display device assembly according to the first embodiment, the focal length of each of the first lens, the second lens, and the third lens is adjusted based on the emission intensity distribution of each of the first light emitting element, the second light emitting element, and the third light emitting element. Furthermore, in the surface light source device according to the second embodiment and the surface light source device in the liquid crystal display device assembly according to the second embodiment, the focal length of each of the first lens, the second lens, and the third lens is adjusted based on the light intensity distributions on the light diffuser, of light beams emitted from the first light emitting element, the second light emitting element, and the third light emitting element. By adjusting the focal lengths of the respective lenses in this manner, the luminance of the area illuminated by the first light emitting element assembly, the luminance of the area illuminated by the second light emitting element assembly, and the luminance of the area illuminated by the third light emitting element assembly can be uniformed on the light diffuser for example. Furthermore, in the surface light source device according to the first embodiment and the surface light source device in the liquid crystal display device assembly according to the first embodiment, the lateral magnification of each of the first lens, the second lens, and the third lens is adjusted based on the emission intensity distribution of each of the first light emitting element, the second light emitting element, and the third light emitting element. By adjusting the lateral magnifications of the respective lenses in this manner, the size of the area illuminated by the first light emitting element assembly, the size of the area illuminated by the second light emitting element assembly, and the size of the area illuminated by the third light emitting element assembly can be uniformed on the light diffuser for example. As a result of the above-described features, it is possible to provide a surface light source device having such configuration and structure as to hardly cause color unevenness even if the emission intensity distributions of the light emitting elements that emit light beams of three primary colors of light are different from each other, and a liquid crystal display device assembly including this surface light source device.

Additional features and advantages are described herein, and will be apparent from the following Detailed Description and the figures.

### BRIEF DESCRIPTION OF THE FIGURES

FIGS. 1A and 1B are a schematic sectional view of a light emitting element assembly in a surface light source device according to a first embodiment and a conceptual diagram of the arrangement and so on of a light emitting element, a lens, and a light diffuser, respectively;

FIG. 2 is a conceptual diagram of a liquid crystal display device assembly including a liquid crystal display device and the surface light source device according to the first embodiment;

FIG. 3 is a conceptual diagram of one part of a drive circuit suitable for use in the first embodiment;

FIG. 4 is a schematic partial end view of the liquid crystal display device assembly including the liquid crystal display device and the surface light source device according to the first embodiment;

FIG. 5 is a schematic partial end view of the liquid crystal display device in the first embodiment;

FIG. 6 is a flowchart for explaining a method for driving a surface light source device of a division driving system;

FIGS. 7A and 7B are conceptual diagrams for explaining a state in which the light source luminance sy2 of a surface light source unit is increased/decreased under control by a surface light source unit drive circuit in order for the surface light source unit to provide a second defined value sy2 of the displaying luminance obtained when it is assumed that a pixel is supplied with a control signal corresponding to a drive signal having the value equal to a maximum value sxU-max in a display area unit;

FIG. 8A is a diagram schematically showing the relationship between the duty ratio (=tON/tConst) and the value obtained by raising the value of a drive signal input to a liquid crystal display device drive circuit in order to drive a sub-pixel to the power of 2.2 (sx′=sx2.2), and FIG. 8B is a diagram schematically showing the relationship between the displaying luminance sy and the value SX of a control signal for controlling the light transmission of the sub-pixel;

FIG. 9 is a conceptual diagram for explaining a state in which the desired illuminance distribution as a function of the output angle (radiation angle) of a light emitting element is set from the radiation angle distribution of the light emitting element;

FIGS. 10A and 10B are schematic sectional views of light emitting elements; and

FIGS. 11A and 11B are schematic sectional views of light emitting element assemblies in a surface light source device according to a second embodiment of the present invention.

### DETAILED DESCRIPTION

The present application is described below with reference to the drawings according to an embodiment.

The surface light source device according to a first embodiment of the present invention and the surface light source device in the liquid crystal display device assembly according to the first embodiment of the present invention (hereinafter, they will be often referred to collectively as “the surface light source device according to the first embodiment of the present invention” simply) may have, but not limited to, a configuration in which P×Q surface light source units are provided that are independently controlled regarding driving and correspond to P×Q virtual display area units defined based on the assumption that the display area of the liquid crystal display device is divided into the P×Q display area units, and each of the surface light source units includes at least one light emitting element unit. Such a configuration will be often referred to as a “surface light source device of a division driving system,” for convenience. Furthermore, in the surface light source device according to the first embodiment of the present invention, including this preferred configuration, it is desirable that a light diffuser is disposed above the plurality of light emitting element units.

On the other hand, for the surface light source device according to the second embodiment of the present invention and the surface light source device in the liquid crystal display device assembly according to the second embodiment of the present invention (hereinafter, they will be often referred to collectively as “the surface light source device according to the second embodiment of the present invention” simply), it is preferable to employ a form in which the light intensity distributions on the light diffuser, of light beams emitted from the first light emitting element, the second light emitting element, and the third light emitting element are compared with desired light intensity distributions on the light diffuser, and the focal length of each of the first lens, the second lens, and the third lens is so adjusted that the difference, obtained as a result of the comparison, between the desired light intensity distributions and the light intensity distributions on the light diffuser, of the light beams emitted from the first light emitting element, the second light emitting element, and the third light emitting element becomes the minimum.

Furthermore, the surface light source devices according to the first embodiment and the second embodiment of the present invention, including the above-described preferred configurations, may have a configuration in which

the first lens is disposed on the first light emitting element with the intermediary of no gap,

the second lens is disposed on the second light emitting element with the intermediary of no gap, and

the third lens is disposed on the third light emitting element with the intermediary of no gap.

That is, in such a preferred configuration, the lens is used also as a sealing component. If an undesired gap is not formed between the light emitting element and the lens as above, light emitted from the light emitting element is not directed toward an unintended direction and the light direction can be easily controlled. The method for obtaining such a preferred configuration depends on the material of the lens. If e.g. a silicone resin (refractive index: e.g. 1.41 to 1.59) or an epoxy resin (refractive index: e.g. 1.40 to 1.74) is used as the material of the lens, this configuration can be obtained by compression molding or transfer molding.

However, the present application is not limited to such a configuration, but it is also possible to employ a form in which the light emitting element is opposed to the lens with the intermediary of a light transmissive medium layer therebetween. Alternatively, it is also possible to employ a form in which an air layer exists between the lens and the light emitting element and light from the light emitting element enters the lens via the air layer. Examples of the material of the light transmissive medium layer include an epoxy resin (refractive index: e.g. 1.5), gel materials (e.g. OCK-451 (product name, refractive index: 1.51) and OCK-433 (product name, refractive index: 1.46) made by Nye corporation), silicone rubber, oil compound materials such as a silicone oil compound (e.g. TSK5353 (product name, refractive index: 1.45) made by Toshiba Silicone Co., Ltd.) that are transparent to light emitted from the light emitting element.

A luminescent particle may be mixed in the light transmissive medium layer. Mixing a luminescent particle in the light transmissive medium layer can widen the width of selection of the light emitting element (the width of selection of the emission wavelength). Examples of the luminescent particle include a red light emitting fluorescent particle, a green light emitting fluorescent particle, and a blue light emitting fluorescent particle. Examples of the material of the red light emitting fluorescent particle include Y₂O₃:Eu, YVO₄:Eu, Y(P, V)O₄:Eu, 3.5MgO.0.5MgF₂.Ge₂:Mn, CaSiO₃:Pb, Mn, Mg₆AsO₁₁:Mn, (Sr, Mg)₃(PO₄)₃:Sn, La₂O₂S:Eu, Y₂O₂S:Eu, (ME:Eu)S (“ME” denotes at least one kind of atom selected from the group consisting of Ca, Sr, and Ba, and the same applies hereinafter), (M:Sm)ₓ(So, Al)₁₂(O, N)₁₆ (“M” denotes at least one kind of atom selected from the group consisting of Li, Mg, and Ca, and the same applies hereinafter), ME₂Si₅N₈:Eu, (Ca:Eu)SiN₂, and (Ca:Eu)AlSiN₃. Examples of the material of the green light emitting fluorescent particle include LaPO₄:Ce, Tb, BaMgAl₁₀O₁₇:Eu, Mn, Zn₂SiO₄:Mn, MgAl₁₁O₁₉:Ce, Tb, Y₂SiO₅:Ce, Tb, and MgAl₁₁O₁₉:CE, Tb, Mn. Further examples thereof include (ME:Eu)Ga₂S₄, (M:RE)ₓ(Si, Al)₁₂(O, N)₁₆ (“RE” denotes Tb or Yb), (M:Tb)ₓ(Si, Al)₁₂(O, N)₁₆, and (M:Yb)(Si, Al)₁₂(O, N)₁₆. Examples of the material of the blue light emitting fluorescent particle include BaMgAl₁₀O₁₇:Eu, BaMg₂Al₁₆O₂₇:Eu, Sr₂P₂O₇:Eu, Sr₅(PO₄)₃Cl:Eu, (Sr, Ca, Ba, Mg)₅(PO₄)₃Cl:Eu, CaWO₄, and CaWO₄:Pb. However, the luminescent particle is not limited to the fluorescent particle. It is also possible to employ e.g. a luminescent particle obtained by applying, in an indirect silicon material, a quantum well structure such as a two-dimensional quantum well structure, a one-dimensional quantum well structure (quantum wire), or a zero-dimensional quantum well structure (quantum dot) in which the wave function of carriers is localized and the quantum effect is used so that the carriers may be converted into light efficiently like in a direct material. Furthermore, it is known that a rare-earth atom added to a semiconductor material sharply emits light due to intrashell transition, and a luminescent particle obtained by applying such a technique can also be employed.

Moreover, the surface light source devices according to the first embodiment and the second embodiment of the present invention, including the above-described preferred forms and configurations may have, but not limited to, a form in which each light emitting element unit is composed of one first light emitting element assembly that emits red light (with a wavelength of e.g. 640 nm), two second light emitting element assemblies that emit green light (with a wavelength of e.g. 530 nm), and one third light emitting element assembly that emits blue light (with a wavelength of e.g. 450 nm). In this case, four light emitting element assemblies may be disposed at four corners of a rectangle. Alternatively, it is also possible to employ a form in which each light emitting element unit is composed of one first light emitting element assembly that emits red light, one second light emitting element assembly that emits green light, and one third light emitting element assembly that emits blue light. In this case, three light emitting element assemblies may be disposed at the vertexes of an equilateral triangle. Each light emitting element unit may further include a light emitting element assembly that emits light of a fourth color, a fifth color, . . . other than red, green, and blue as three primary colors of light.

It is possible to employ a configuration (face-up structure) in which the light emitting element is formed of e.g. a light emitting diode (LED) composed of a base and a light emitting layer formed on the base and the lens is opposed to the light emitting layer of the light emitting diode. Alternatively, it is also possible to employ a configuration (flip-chip structure) in which the light emitting element is formed of e.g. a light emitting diode composed of a base and a light emitting layer formed on the base and the lens is opposed to the base. In the flip-chip structure, light is output via the base.

The light emitting diode (LED) has e.g. a multilayer structure composed of a first compound semiconductor layer of a first conductivity type (e.g. n-type) formed on the base, an active layer formed on the first compound semiconductor layer, and a second compound semiconductor layer of a second conductivity type (e.g. p-type) formed on the active layer. The light emitting diode includes a first electrode electrically connected to the first compound semiconductor layer and a second electrode electrically connected to the second compound semiconductor layer. The layers of the light emitting diode depend on the emission wavelength and may be formed of known compound semiconductor materials. The base may also be formed of a known material, such as sapphire (refractive index: 1.785), GaN (refractive index: 2.438), GaAs (refractive index: 3.4), AlInP (refractive index: 2.86), or alumina (refractive index: 1.78).

In general, the color temperature of the light emitting diode depends on the operating current. Therefore, in order to truly reproduce the color while obtaining the desired luminance, i.e. in order to keep the color temperature constant, it is preferable to drive the light emitting diode by a pulse width modulation (PWM) signal. If the duty ratio of the pulse width modulation (PWM) signal is changed, the luminance by the average forward current in the light emitting diode linearly changes.

The light emitting element is generally attached to a substrate. It is preferable that the substrate be, but not limited to, a substrate that has resistance against heat generated by the light emitting element and is excellent in the heat release property. Specific examples of the substrate include a metal core printed wiring board having interconnects formed on its single surface or both surfaces, a multilayer metal core printed wiring board, a metal base printed wiring board having interconnects formed on its single surface or both surfaces, a multilayer metal base printed wiring board, a ceramic wiring board having interconnects formed on its single surface or both surfaces, and a multilayer ceramic wiring board. A known method may be used as the method for manufacturing these various kinds of printed wiring boards. Furthermore, as a method for electrical connection (mounting) of the light emitting element to the circuit formed on the substrate, a die bonding method, a wire bonding method, a combination of these methods, or a system of using a submount may be used although depending on the structure of the light emitting element. Examples of the die bonding method include a method of using a solder ball, a method of using a solder paste, a method of melting an AuSn eutectic solder for bonding, and a method of forming a gold bump and using ultrasonic waves for bonding. A known attachment method may be used as the method for attaching the light emitting element to the substrate. Furthermore, it is desirable to fix the substrate to a heat sink.

The light exit surface of the lens may be a sphere or may be a nonsphere. Alternatively, it may be formed of any curve. The focal length of the lens can be changed by varying the shape of the light exit surface of the lens. That is, changing the focal length of the lens is equivalent to changing (adjusting) the shape of the light exit surface of the lens. Furthermore, the lateral magnification of the lens can be changed by varying the distance from the light exit surface of the light emitting element to the light exit surface of the lens. Changing the lateral magnification of the lens is equivalent to changing the size of a projected image obtained when light output from the lens is projected on a certain plane. The distance from the light exit surface of the light emitting element to the light exit surface of the lens refers to the distance from the light exit surface of the light emitting element to the light exit surface of the lens along the optical axis of the lens. In the surface light source devices according to the first embodiment and the second embodiment, it is preferable that the first lens, the second lens, and the third lens have the same diameter (the diameter of the light exit surface of the lens having a curved surface). This is because, if the diameter is the same, a common configuration can be employed as the configuration of most part of the light emitting elements that should be prepared as a respective one of the first light emitting element, the second light emitting element, and the third light emitting element. The curve representing the light exit surface of the lens, obtained when the lens is cut along a virtual plane including the optical axis, may be any as long as it is a smooth curve. Although the function form of the curve cannot be uniquely decided, the curve can be represented by e.g. the combination of polynomials of second or higher order (i.e. the curve has small intervals each represented by a polynomial of second or higher order and is formed by smooth coupling of these polynomials of second or higher order). Alternatively, the curve can be represented by the combination of functions approximated by polynomials of second or higher order (i.e. the curve has small intervals each represented by a function approximated by a polynomial of second or higher order and is formed by smooth coupling of these functions approximated by the polynomials of second or higher order). However, the lens surface does not have to be a smooth curve in the invalid area such as a peripheral part through which light does not pass actually although it is also included in the light exit surface. It is desirable that the light exit surface of the lens has, but not limited to, a shape that is rotationally symmetric about the optical axis of the lens. The center of the light exit surface of the lens may be congruous with the optical axis of the lens or may be incongruous with the optical axis depending on the case.

If the refractive index of the material of the lens is defined as n₁, it is desirable that n₁ is in the range of 1.35≦n₁≦2.5, preferably 1.4≦n₁≦1.8. As the material of the lens, a material used for glasses lens can be used. Specific examples of the material include plastic materials having a high refractive index, such as Prestige (product name, refractive index: 1.74) made by SEIKO OPTICAL PRODUCTS CO., LTD., ULTIMAX V AS 1.74 (product name, refractive index: 1.74) made by SHOWA OPT. CO., LTD., and NL5-AS (product name, refractive index: 1.74) made by Nikon-Essilor Co., Ltd. In addition, the specific examples of the material further include various kinds of plastic materials such as PMMA, a polycarbonate resin, an acrylic resin, an amorphous polypropylene resin, a styrene resin containing an AS resin, a silicone resin, and ZEONOR (made by ZEON CORPORATION), which is a norbornene polymer resin. Moreover, the specific examples of the material further include optical glass such as NBFD11 (refractive index n₁: 1.78), M-NBFD82 (refractive index n₁: 1.81), and M-LAF81 (refractive index n₁: 1.731), which are glass materials made by HOYA CORPORATION. In the case of forming the lens by using a thermoplastic material that can be injection-molded, the lens can be formed by injection molding. In the case of forming the lens by using a thermosetting material, the lens can be obtained by compression molding or transfer molding.

In the surface light source devices according to the first embodiment and the second embodiment, including the above-described preferred forms and configurations, the light emitting element can be so disposed as to be surrounded by a reflector. Specifically, by disposing the light emitting element at the center of the reflector having a mortar shape, light emitted from the light emitting element is reflected by the reflector. As a result, the light emission efficiency as the entire light emitting element can be enhanced. The light reflecting film is provided on the reflector. This light reflecting film can be formed of e.g. a high reflection film. As the high reflection film, e.g. a high reflection film having a structure obtained by stacking a low refractive index film and a high refractive index film in turn can be used. Furthermore, the following films can also be used: a dielectric multilayer reflecting film having a structure obtained by alternately stacking a low refractive index thin film composed of SiO₂ or the like and a high refractive index thin film composed of TiO₂, Ta₂O₅, or the like to several layers; and a light reflecting film as an organic polymer multilayer thin film fabricated by stacking polymer films that have different refractive indexes and each have a thickness on the order of sub-microns. Alternatively, a metal thin film such as a silver thin film, a chromium thin film, or an aluminum thin film or an alloy thin film can be used as the light reflecting film. If the light reflecting film has a sheet shape, a film shape, or a plate shape, the light reflecting film can be fixed to the reflector by a method of using an adhesive, a method of adhering the light reflecting film by ultrasonic bonding, a method of using a tackiness agent, or the like. Alternatively, the light reflecting film can be deposited on the reflector by a known film deposition method such as a PVD (Physical Vapor Deposition) method or a CVD (Chemical Vapor Deposition) method typified by e.g. vacuum evaporation and sputtering.

The surface light source device may include not only the light diffuser but also a reflecting sheet and an optical functional sheet (film) group including e.g. a diffusion sheet, a prism sheet (film), a BEF, a DBEF (they are the product names of products made by Sumitomo 3M Limited), and a polarization conversion sheet (film). The optical functional sheet group may be composed of various sheets that are disposed separately from each other or may be composed of sheets that are stacked and formed monolithically with each other. The light diffuser and the optical functional sheet group are disposed between the surface light source device and so on and the liquid crystal display device. Examples of the material of the light diffuser include a polycarbonate (PC) resin, a polystyrene (PS) resin, a methacryl resin, and a cycloolefin resin such as ZEONOR (made by ZEON CORPORATION), which is a norbornene polymer resin.

It is also possible to separate the surface light source units from each other by partitions. The passage or reflection or both of light emitted from the light source included in the surface light source unit is controlled by the partitions. In this case, one surface light source unit is surrounded by four partitions, or by one side surface of the case of the surface light source device and so on and three partitions, or by two side surfaces of the case and two partitions. Specific examples of the material of the partition include an acrylic resin, a polycarbonate resin, and an ABS resin as materials that are not transparent to light emitted from the light source included in the surface light source unit. In addition, the specific examples further include a polymethylmethacrylate (PMMA) resin, a polycarbonate (PC) resin, a polyarylate resin (PAR), a polyethylene terephthalate (PET) resin, and glass as materials that are transparent to light emitted from the light source included in the surface light source unit. The partition surface may be provided with a light diffuse reflection function or may be provided with a specular reflection function. To provide the partition surface with the light diffuse reflection function, projections and recesses are formed on the partition surface based on sandblasting or a film having projections and recesses (light diffusion film) is attached to the partition surface. To provide the partition surface with the specular reflection function, a light reflecting film is attached to the partition surface or a light reflecting layer is formed on the partition surface by e.g. plating.

As the liquid crystal display device, a transmissive or semi-transmissive color liquid crystal display device can be employed. These liquid crystal display devices are composed of e.g. a front panel including a transparent first electrode, a rear panel including transparent second electrodes, and a liquid crystal material disposed between the front panel and the rear panel.

Specifically, the front panel is composed of e.g. a first substrate formed of a glass substrate or a silicon substrate, the transparent first electrode (referred to also as a common electrode and composed of e.g. ITO) provided over the inside surface of the first substrate, and a polarizing film provided on the outside surface of the first substrate. Moreover, for the front panel, a color filter covered by an overcoat layer composed of an acrylic resin or an epoxy resin is provided on the inside surface of the first substrate. The color filter is generally composed of a black matrix (composed of e.g. chromium) for blocking light through the gap between the colored patterns and a colored layer of e.g. blue, green, and red, opposed to the respective sub-pixels. The color filter is fabricated by staining, pigment dispersion, printing, electrodeposition, or another method. The colored layer is composed of e.g. a resin material or is colored by a pigment. The pattern of the colored layer is matched with the arrangement state (arrangement pattern) of the sub-pixels. Examples of the pattern include a delta arrangement, a stripe arrangement, a diagonal arrangement, and a rectangle arrangement. In the front panel, the transparent first electrode is formed on the overcoat layer. An alignment film is formed on the transparent first electrode. On the other hand, the rear panel includes, specifically, e.g. a second substrate formed of a glass substrate or a silicon substrate, switching elements formed on the inside surface of the second substrate, the transparent second electrodes (referred to also as pixel electrodes and composed of e.g. ITO) controlled by the switching elements regarding the conductive/non-conductive state, and a polarizing film provided on the outside surface of the second substrate. An alignment film is formed over the entire surface including the transparent second electrode. Known components and material can be used as various components and the liquid crystal material of the transmissive or semi-transmissive color liquid crystal display device. Examples of the switching element include three-terminal elements such as a MOS (Metal Oxide Semiconductor) FET (Field-Effect Transistor) formed in a single-crystal silicon semiconductor substrate and a thin film transistor (TFT) formed on a glass substrate, and two-terminal elements such as a MIM (Metal Insulator Metal) element, a variable resistor element, and a diode. As the drive system for the liquid crystal material, a drive system suitable for the liquid crystal material that is used is employed.

Examples of the first substrate and the second substrate include a glass substrate, a glass substrate having an insulating film formed on its surface, a quartz substrate, a quartz substrate having an insulating film formed on its surface, and a semiconductor substrate having an insulating film formed on its surface. In terms of reduction in the manufacturing cost, it is preferable to use a glass substrate or a glass substrate having an insulating film formed on its surface. Examples of the glass substrate include high strain point glass, soda glass (Na₂O.CaOSiO₂), borosilicate glass (Na₂O.B₂O₃.SiO₂), forsterite (2MgO.SiO₂), lead glass (Na₂O.PbO.SiO₂), and alkali-free glass. Alternatively, an organic polymer (having the form of a polymer component, such as a plastic film, a plastic sheet, and a plastic substrate, that is composed of a polymer material and has flexibility) can be used. Examples of the organic polymer include polymethylmethacrylate (PMMA), polyvinyl alcohol (PVA), polyvinylphenol (PVP), polyethersulfone (PES), polyimide, polycarbonate (PC), and polyethylene terephthalate (PET).

The area that is the overlapping area between the transparent first electrode and the transparent second electrode and includes a liquid crystal cell corresponds to one sub-pixel. In the transmissive color liquid crystal display device, a red light emitting sub-pixel (it will be often referred to as a sub-pixel [R]) included in each pixel is formed of the combination of the liquid crystal cell of this area and a color filter through which red light passes. A green light emitting sub-pixel (it will be often referred to as a sub-pixel [G]) is formed of the combination of the liquid crystal cell of this area and a color filter through which green light passes. A blue light emitting sub-pixel (it will be often referred to as a sub-pixel [B]) is formed of the combination of the liquid crystal cell of this area and a color filter through which blue light passes. The arrangement pattern of the sub-pixel [R], the sub-pixel [G], and the sub-pixel [B] corresponds with the above-described arrangement pattern of the color filter. The pixel is not limited to a configuration in which the sub-pixel [R], the sub-pixel [G], and the sub-pixel [B], i.e. three kinds of sub-pixels [R, G, B], are collected as one group. For example, it is also possible that the pixel is formed of one sub-pixel group obtained by adding one kind or plural kinds of sub-pixels to these three kinds of sub-pixels [R, G, B]. Examples of such one sub-pixel group include one group obtained by adding a sub-pixel that emits white light for luminance enhancement, one group obtained by adding a sub-pixel that emits a complementary color for extension of the color reproduction range, one group obtained by adding a sub-pixel that emits yellow for extension of the color reproduction range, one group obtained by adding a sub-pixel that emits magenta for extension of the color reproduction range, and one group obtained by adding sub-pixels that emit yellow and cyan for extension of the color reproduction range. If the sub-pixel for extending the color gamut is added, a fourth light emitting element assembly and a fifth light emitting element assembly may be correspondingly added to the light emitting element assemblies included in the surface light source unit. In the case of a so-called field sequential liquid crystal display device, which carries out color displaying by switching the light emission state among red, green, and blue at high speed in a time division manner, a color filter formed separately for each sub-pixel is unnecessary. In this case, the light emission colors of the light emitting element assemblies included in the surface light source unit are selected similarly to the above-described combination of the color filter.

In the surface light source device according to the second embodiment of the present invention and in the surface light source device of the division driving system as a preferred form of the surface light source device according to the first embodiment (hereinafter, they will be referred to collectively as “the surface light source device of the division driving system of the present invention”), it is desirable to provide an optical sensor for measuring the light emission state of the light emitting element (specifically, e.g. the luminance of the light source or the chromaticity of the light source or both). It is sufficient that the number of optical sensors is one. However, a configuration in which one optical sensor corresponds to one surface light source unit is desirable in terms of ensured measurement of the light emission state of each surface light source unit. As the optical sensor, a known photodiode or CCD (Charge Coupled Device) can be used.

In the surface light source device of the division driving system, the light transmission (referred to also as the aperture ratio) Lt of the sub-pixel, the luminance (displaying luminance) sy of the part of the display area corresponding to the sub-pixel, and the luminance (light source luminance) SY of the surface light source unit are defined as follows. SY₁ . . . e.g. the highest luminance of the light source luminance, hereinafter SY₁ will be often referred to as the first defined value of the light source luminance. Lt₁ . . . e.g. the maximum value of the light transmission (aperture ratio) of the sub-pixel in the display area unit, hereinafter Lt₁ will be often referred to as the first defined value of the light transmission. Lt₂ . . . the light transmission (aperture ratio) of the sub-pixel when it is assumed that the sub-pixel is supplied with the control signal corresponding to the drive signal having the value equal to the drive signal maximum value sx_{U-max} in the display area unit as the maximum value among the values of the drive signals input to the drive circuitry in order to drive all of the pixels included in the display area unit when the light source luminance is the first defined value SY₁ of the light source luminance, hereinafter Lt₂ will be often referred to as the second defined value of the light transmission. Lt₁ and Lt₂ satisfy a relationship of 0≦Lt₂≦Lt₁.

sy₂ . . . the displaying luminance obtained when it is assumed that the light source luminance is the first defined value SY₁ of the light source luminance and the light transmission (aperture ratio) of the sub-pixel is the second defined value Lt₂ of the light transmission, hereinafter sy₂ will be often referred to as the second defined value of the displaying luminance.

SY₂ . . . the light source luminance of the surface light source unit for setting the luminance of the sub-pixel to the second defined value (sy₂) of the displaying luminance when it is assumed that the sub-pixel is supplied with the control signal corresponding to the drive signal having the value equal to the drive signal maximum value sx_{U-max} in the display area unit and the light transmission (aperture ratio) of the sub-pixel at the time is corrected to the first defined value Lt₁ of the light transmission. Correction in consideration of the influence of the light source luminance of the surface light source unit on the light source luminance of the other surface light source units is carried out for the light source luminance SY₂ in some cases.

At the time of the division driving of the surface light source device of the present invention, the luminance of the light emitting element in the surface light source unit corresponding to the display area unit is so controlled by the drive circuitry as to provide the luminance of the pixel (the second defined value sy₂ of the displaying luminance in response to the first defined value Lt₁ of the light transmission) obtained when it is assumed that the pixel is supplied with the control signal corresponding to the drive signal having the value equal to the drive signal maximum value sx_{U-max} in the display area unit. Specifically, for example, the light source luminance SY₂ is so controlled (e.g. decreased) that the displaying luminance sy₂ is obtained when the light transmission (aperture ratio) of the sub-pixel is set to e.g. the first defined value Lt₁ of the light transmission. That is, for example, the light source luminance SY₂ of the surface light source unit is so controlled for each of frames in image displaying of the liquid crystal display device (referred to as the image displaying frame, for convenience) that the following equation (A) is satisfied. SY₂ and SY₁ satisfy the relationship of SY₂≦SY₁.

SY₂·Lt₁=SY₁Lt₂ (A)

The drive circuitry can be formed of e.g. a surface light source device control circuit and a surface light source unit drive circuit that include a pulse width modulation (PWM) signal generation circuit, a duty ratio control circuit, a light emitting element drive circuit, an arithmetic circuit, a storage device (memory), and so on, and a liquid crystal display device drive circuit including known circuits such as a timing controller. The control of the luminance (displaying luminance) of the part of the display area and the luminance (light source luminance) of the surface light source unit is carried out for every image displaying frame. The number of pieces of image information sent to the drive circuitry as an electric signal per one second (images per second) is the frame frequency (frame rate), and an inverse of the frame frequency is the frame time (unit: seconds).

If the number M₀×N₀ of pixels arranged in a two-dimensional matrix is represented as (M₀, N₀), specific examples of the value of (M₀, N₀) include the following image displaying resolutions: VGA (640, 480), S-VGA (800, 600), XGA (1024, 768), APRC (1152, 900), S-XGA (1280, 1024), U-XGA (1600, 1200), HD-TV (1920, 1080), Q-XGA (2048, 1536), (1920, 1035), (720, 480), and (1280, 960). However, the number of pixels is not limited to these values. If the division driving system is employed, the relationships between the value of (M₀, N₀) and the value of (P, Q) can be shown in, but not limited to, Table 1 shown below. As the number of pixels included in one display area unit, a number in the range of 20×20 to 320×240, preferably in the range of 50×50 to 200×200, can be employed. The number of pixels in the display area unit may be constant or may have variation.

TABLE 1

| | value of P | value of Q |
|---|---|---|
| VGA (640, 480) | 2 to 32 | 2 to 24 |
| S-VGA (800, 600) | 3 to 40 | 2 to 30 |
| XGA (1024, 768) | 4 to 50 | 3 to 39 |
| APRC (1152, 900) | 4 to 58 | 3 to 45 |
| S-XGA (1280, 1024) | 4 to 64 | 4 to 51 |
| U-XGA (1600, 1200) | 6 to 80 | 4 to 60 |
| HD-TV (1920, 1080) | 6 to 86 | 4 to 54 |
| Q-XGA (2048, 1536) | 7 to 102 | 5 to 77 |
| (1920, 1035) | 7 to 64 | 4 to 52 |
| (720, 480) | 3 to 34 | 2 to 24 |
| (1280, 960) | 4 to 64 | 3 to 48 |

If the division driving system (partial driving system) is employed in the surface light source device and the luminance of the light source (light emitting element assembly) in the surface light source unit corresponding to the display area unit is so controlled by the drive circuitry as to provide the luminance of the pixel (the second defined value sy₂ of the displaying luminance in response to the first defined value Lt₁ of the light transmission) obtained when it is assumed that the pixel is supplied with the control signal corresponding to the drive signal having the value equal to the drive signal maximum value sx_{U-max} in the display area unit, the power consumption of the surface light source device can be reduced. In addition, through increase in the white level and the lowering of the black level, a high contrast ratio (the luminance ratio between the all-black display part and the all-white display part on the screen surface of the liquid crystal display device, not including external light reflection and so on) can be obtained. Thus, the luminance of the desired display area can be highlighted and therefore the quality of the image displaying can be enhanced.

### First Embodiment

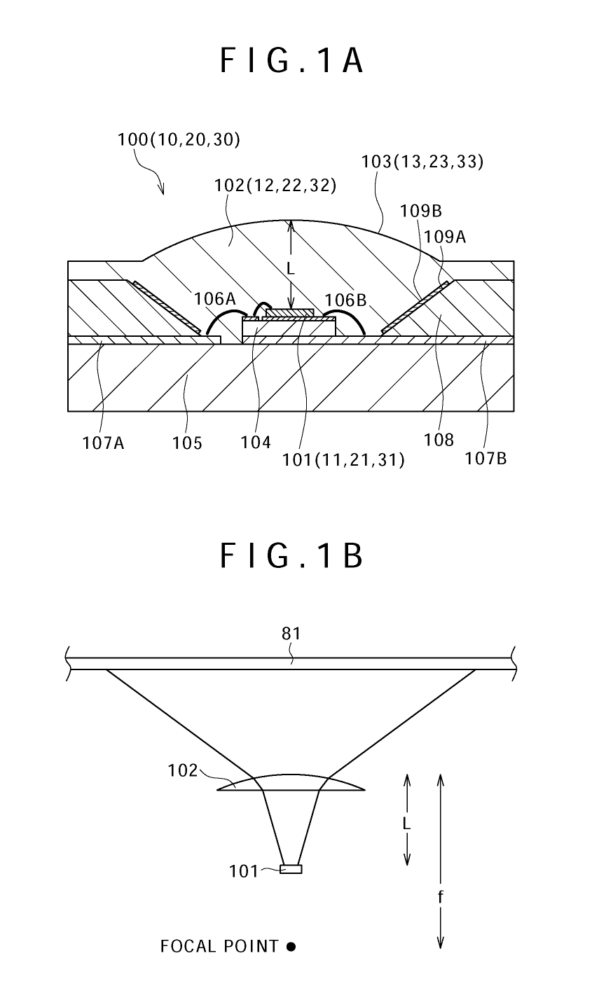

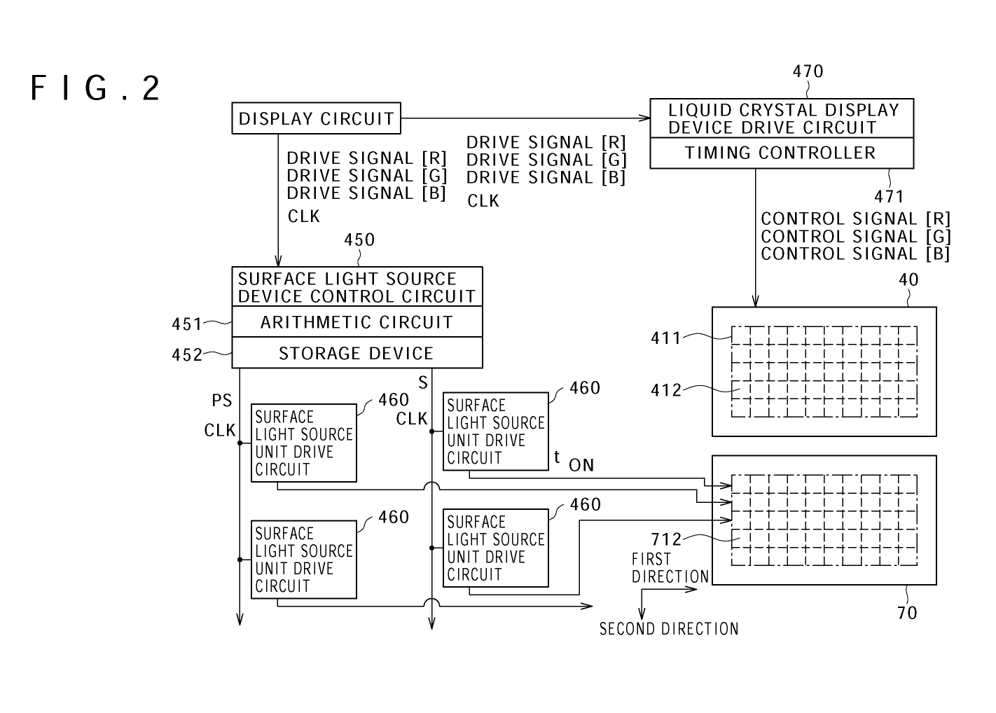

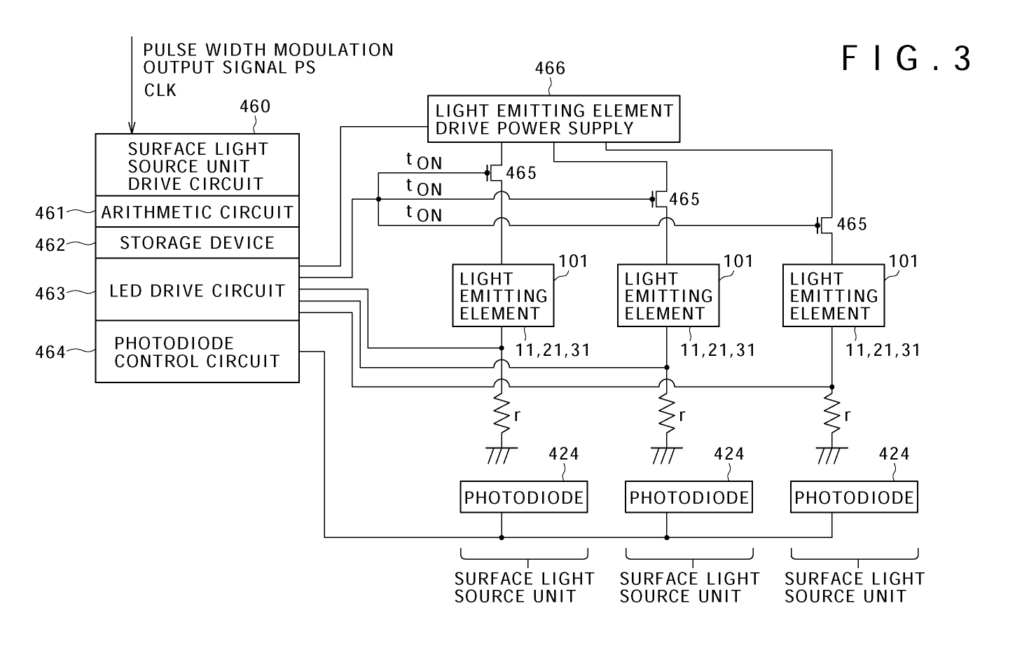

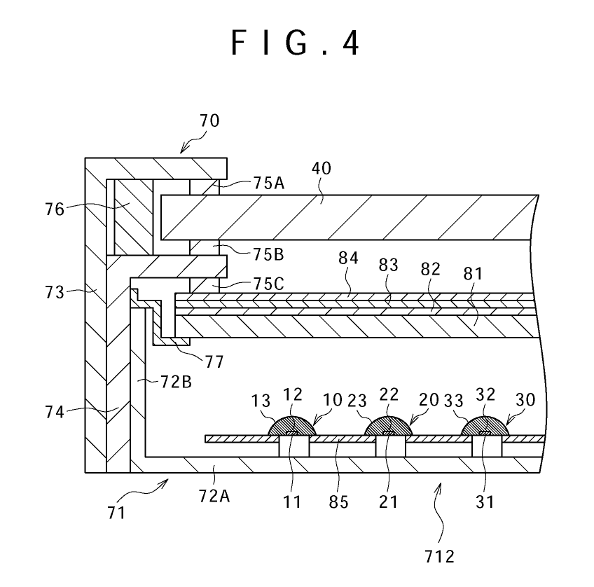

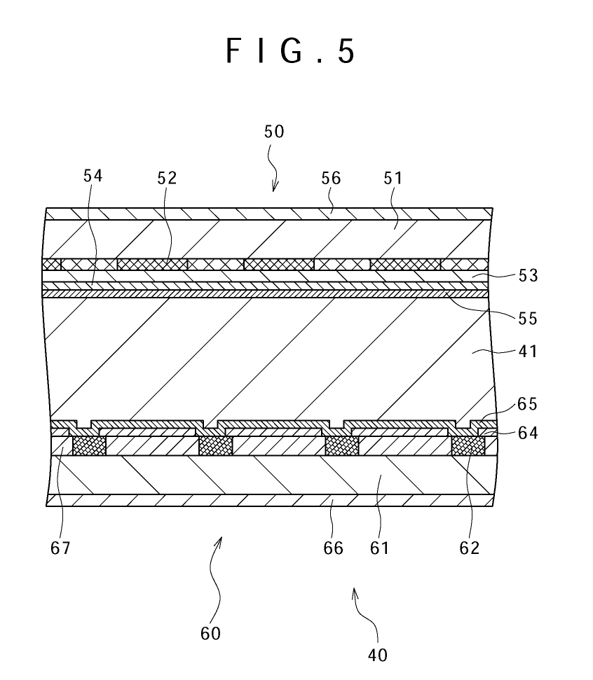

A first embodiment relates to the surface light source devices and the liquid crystal display device assemblies according to the first embodiment and the second embodiment of the present invention. Conceptual diagrams of the liquid crystal display device assembly of the first embodiment are shown in FIGS. 2 and 3. A schematic sectional view of a light emitting element assembly is shown in FIG. 1A. A schematic partial end view of the liquid crystal display device assembly is shown in FIG. 4. A schematic partial end view of a liquid crystal display device is shown in FIG. 5.

The surface light source device of the first embodiment illuminates a transmissive liquid crystal display device having a display area 411 formed of pixels arranged in a two-dimensional matrix, from the back side of the liquid crystal display device. Furthermore, as shown in the conceptual diagrams of FIGS. 2 and 3, the liquid crystal display device assembly of the first embodiment includes

(1) a transmissive liquid crystal display device (in the first embodiment, a color liquid crystal display device 40) having the display area 411 formed of pixels arranged in a two-dimensional matrix, and

(2) a surface light source device 70 that illuminates the liquid crystal display device (the color liquid crystal display device 40) from the back side of the liquid crystal display device.

Description of the first embodiment based on the expression of the surface light source device according to the first embodiment of the present invention is as follows. Specifically, the surface light source device includes a plurality of light emitting element units. The surface light source device includes P×Q surface light source units 712 that are individually controlled regarding driving and correspond to P×Q virtual display area units 412 defined based on the assumption that the display area 411 of the liquid crystal display device (the color liquid crystal display device 40) is divided into P×Q display area units 412. Each of the surface light source units 712 includes at least one light emitting element unit. Furthermore, a light diffuser 81 is disposed above the plurality of light emitting element units.

On the other hand, description of the first embodiment based on the expression of the surface light source device according to the second embodiment of the present invention is as follows. Specifically, the surface light source device includes P×Q surface light source units 712 that are individually controlled regarding driving and correspond to P×Q virtual display area units 412 defined based on the assumption that the display area 411 of the liquid crystal display device (the color liquid crystal display device 40) is divided into P×Q display area units 412. The light diffuser 81 is disposed above P×Q surface light source units 712. Each of the surface light source units 712 includes at least one light emitting element unit.

In addition, if the first embodiment is described based on the expression of the surface light source devices according to the first embodiment and the second embodiment of the present invention, each of the light emitting element units includes

(A) at least one (specifically one, in the first embodiment) first light emitting element assembly 10 that is formed of a first light emitting element 11 and a first lens 12 and emits, via the first lens 12, first primary color light (specifically, red light with a wavelength of 640 nm) corresponding to a first primary color of three primary colors of light, composed of the first primary color, a second primary color, and a third primary color,

(B) at least one (specifically two, in the first embodiment) second light emitting element assembly 20 that is formed of a second light emitting element 21 and a second lens 22 and emits, via the second lens 22, second primary color light (specifically, green light with a wavelength of 530 nm) corresponding to the second primary color, and

(C) at least one (specifically one, in the first embodiment) third light emitting element assembly 30 that is formed of a third light emitting element 31 and a third lens 32 and emits, via the third lens 32, third primary color light (specifically, blue light with a wavelength of 450 nm) corresponding to the third primary color.

Furthermore, if the first embodiment is described based on the expression of the surface light source device according to the first embodiment of the present invention, the focal length and lateral magnification of each of the first lens 12, the second lens 22, and the third lens 32 are adjusted based on the emission intensity distribution of each of the first light emitting element 11, the second light emitting element 21, and the third light emitting element 31. Moreover, if the first embodiment is described based on the expression of the surface light source device according to the second embodiment of the present invention, the focal length of each of the first lens 12, the second lens 22, and the third lens 32 is adjusted based on the light intensity distributions on the light diffuser 81, of light beams emitted from the first light emitting element 11, the second light emitting element 21, and the third light emitting element 31. The planar shape of the surface light source unit 712 is a rectangle. In the first embodiment, the first light emitting element assembly 10, the second light emitting element assembly 20, and the third light emitting element assembly 30 are disposed at four corners of the surface light source unit 712 in the order of the first light emitting element assembly 10, the second light emitting element assembly 20, the third light emitting element assembly 30, and the second light emitting element assembly 20.

In the first embodiment, the light intensity distributions (actual measurement values) on the light diffuser 81, of light beams emitted from the first light emitting element 11, the second light emitting element 21, and the third light emitting element 31 are compared with the desired light intensity distributions (design values) on the light diffuser 81 in advance. Furthermore, the focal length and lateral magnification of each of the first lens 12, the second lens 22, and the third lens 32 are simultaneously so adjusted that the difference, obtained as a result of the comparison, between the desired light intensity distributions (design values) and the light intensity distributions on the light diffuser 81, of light beams emitted from the first light emitting element 11, the second light emitting element 21, and the third light emitting element 31 becomes the minimum and the light irradiation areas of these light beams on the light diffuser 81 become identical to each other.

Specifically, the shapes of light exit surfaces 13, 23, and 33 of the lenses 12, 22, and 32 are properly selected and the distances between the light exit surfaces of the light emitting elements 11, 21, and 31 and the light exit surfaces 13, 23, and 33 of the lenses 12, 22, and 32 are properly selected, and simulation is performed. Thereby, calculation values of the light intensity distributions on the light diffuser 81, of light beams emitted from the first light emitting element 11, the second light emitting element 21, and the third light emitting element 31 and calculation values of the sizes of the areas illuminated by the respective light emitting element assemblies 10, 20, and 30 on the light diffuser 81 are obtained. As the illuminated area, the area in which the luminance on the light diffuser 81 exceeds a predetermined threshold value is employed. The focal length of the lens can be changed by varying the shape of the light exit surface of the lens. Furthermore, the lateral magnification of the lens can be changed by varying the distance from the light exit surface of the light emitting element to the light exit surface of the lens. The shape of the light exit surface of the lens is a sphere, a nonsphere, or any other curve. The apertures of the first lens 12, the second lens 22, and the third lens 32 (the diameters of the light exit surfaces of the lenses each having a curved surface) are set to the same aperture. In this manner, until the obtained calculation values of the light intensity distributions and the sizes of the illuminated areas become the desired values of the light intensity distributions and the sizes of the illuminated areas, the calculation is repeated with the change of the shapes of the light exit surfaces 13, 23, and 33 of the lenses 12, 22, and 32 and the distances from the light exit surfaces of the light emitting elements 11, 21, and 31 to the light exit surfaces 13, 23, and 33 of the lenses 12, 22, and 32. A conceptual diagram of the arrangement and so on of the light emitting element, the lens, and the light diffuser is shown in FIG. 1B. In this diagram, the lens acts as e.g. a convex lens, and the light emitting element is disposed between the front focus of the lens and the lens. The virtual image of the light emitting element is projected on the light diffuser by the lens. That is, the apparent size of the light emitting element on the light diffuser can be changed (adjusted).

For convenience of description, the first light emitting element assembly 10, the second light emitting element assembly 20, and the third light emitting element assembly 30 will be often referred to collectively as a light emitting element assembly 100. The first light emitting element 11, the second light emitting element 21, and the third light emitting element 31 will be often referred to collectively as a light emitting element 101. The first lens 12, the second lens 22, and the third lens 32 will be often referred to collectively as a lens 102. The light exit surface 13 of the first lens, the light exit surface 23 of the second lens, and the light exit surface 33 of the third lens will be often referred to collectively as a light exit surface 103.

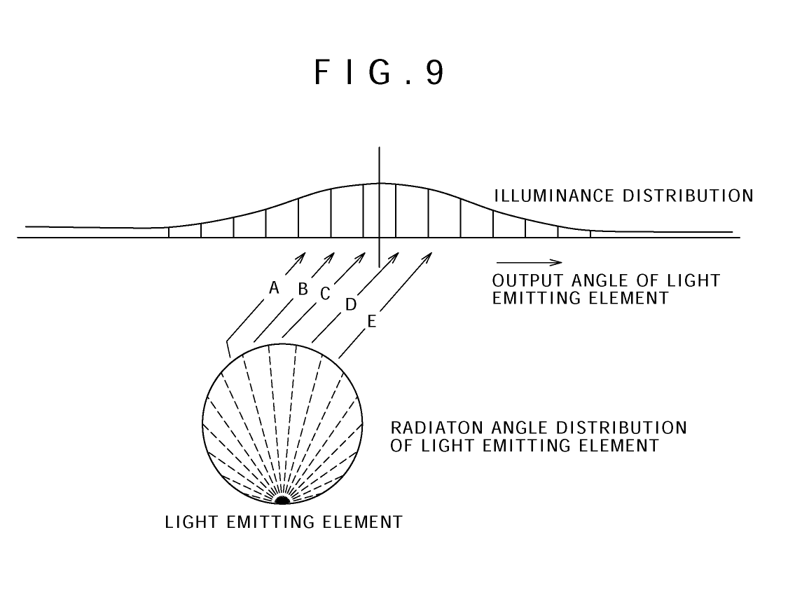

Which curved surface to employ as the light exit surface 103 of the lens 102 can be decided by the method described below for example. Specifically, with correction of the intensity of emitted light based on the transmission at the light exit surface 103 of the lens 102, the surface shape that allows light from the light emitting element 101 to be output with the intended, target output angle is calculated. For this purpose, initially the illuminance distribution (the desired light intensity distribution) as the target is set. For example, as shown in a conceptual diagram of FIG. 9, the desired illuminance distribution as a function of the output angle (radiation angle) of the light emitting element is set from the radiation angle distribution of the light emitting element 101. In FIG. 9, the states indicated by “A,” “B,” “C,” “D,” and “E” show the set illuminance when the output angle (radiation angle) is in the range of −25 degrees to −15 degrees, the range of −15 degrees to −5 degrees, the range of −5 degrees to +5 degrees, the range of 5 degrees to 15 degrees, and the range of 15 degrees to 25 degrees, respectively. Subsequently, the following factors are obtained from calculation: the relationship between the output angle (radiation angle) from the light emitting element 101 and the output angle from the light exit surface 103 of the lens 102, and the angle of light when the light is refracted at the light exit surface 103 of the lens 102 and passes through the light exit surface 103 or is reflected by the light exit surface 103 in the lens 102 (this angle will be referred to as the incidence angle to the light exit surface 103). Thereafter, based on the relationship among the output angle (radiation angle) from the light emitting element 101, the incidence angle to the light exit surface 103, and the output angle from the light exit surface 103 of the lens 102, the inclination angle of a small area of the light exit surface 103 when a light beam emitted from the light emitting element 101 at a certain output angle (radiation angle) is output in the desired direction after colliding with this small area is obtained. By sequentially carrying out such operation, the shape (function) of the light exit surface 103 can be obtained finally.

If the obtained calculation values of the light intensity distributions and the sizes of the illuminated areas are the desired values of the light intensity distributions and the sizes of the illuminated areas, then the lenses 12, 22, and 32 are fabricated and assembled with the light emitting elements 11, 21, and 31 based on the shapes of the light exit surfaces 13, 23, and 33 of the lenses 12, 22, and 32 and the distances from the light exit surfaces of the light emitting elements 11, 21, and 31 to the light exit surfaces 13, 23, and 33 of the lenses 12, 22, and 32 at the time. Thereby, the light emitting element assemblies 10, 20, and 30 can be obtained.

By adjusting the focal lengths of the lenses 12, 22, and 32 in this manner, the luminance of the area illuminated by the first light emitting element assembly 10, the luminance of the area illuminated by the second light emitting element assembly 20, and the luminance of the area illuminated by the third light emitting element assembly 30 can be uniformed on the light diffuser 81. Furthermore, by adjusting the lateral magnifications of the lenses 12, 22, and 32, the size of the area illuminated by the first light emitting element assembly 10, the size of the area illuminated by the second light emitting element assembly 20, and the size of the area illuminated by the third light emitting element assembly 30 can be uniformed on the light diffuser 81. As a result of the above-described features, it is possible to obtain a surface light source device having such configuration and structure as to hardly cause color unevenness even if the emission intensity distributions of light emitting elements that emit light beams of three primary colors of light are different from each other, and a liquid crystal display device assembly including this surface light source device.

The light emitting element assembly 100 includes the light emitting element 101 and the lens 102 as described above, and the lens 102 is disposed on the light emitting element 101 with the intermediary of no gap therebetween. That is, the lens 102 is used also as a sealing component in the first embodiment. The material of the lens 102 is a silicone resin (refractive index: 1.45), and the lens is molded by transfer molding.

In the first embodiment, the light emitting element 101 is formed of a light emitting diode (LED) composed of a base (not shown in FIG. 1) and a light emitting layer (not shown in FIG. 1) formed on the base. A structure in which the lens 102 is opposed to the light emitting layer of the light emitting diode (face-up structure) may be employed. It is also possible to employ a structure in which the lens 102 is opposed to the base and light enters the lens 102 via the base (flip-chip structure). The light emitting diode (LED) has known configuration and structure. The light emitting element 101 is attached to a submount 104, and the submount 104 is fixed to a substrate 105. One electrode (not shown) provided in the light emitting element 101 is connected by a gold jumper 106A to an interconnect 107A provided on the substrate 105. The other electrode (not shown) provided in the light emitting element 101 is connected by a gold jumper 106B to an interconnect 107B provided on the substrate 105.

The base of the first light emitting element (red light emitting diode) 11 that emits red light (with a wavelength of e.g. 640 nm) is composed of GaAs (refractive index nS: 3.4). The bases of the second light emitting element (green light emitting diode) 21 and the third light emitting element (blue light emitting diode) 31 that emit green light (with a wavelength of e.g. 530 nm) and blue light (with a wavelength of e.g. 450 nm) are composed of GaN (refractive index nS: 2.438) or alumina (refractive index nS: 1.78). Known composition, configuration, and structure can be employed as the compositions, configurations, and structures of the light emitting layers of the respective light emitting diodes.

The light emitting element 101 is surrounded by a reflector 108. Specifically, the light emitting element 101 is disposed at the center of the reflector 108 having a mortar shape. A light reflecting film 109B is provided on a slope surface 109A of the reflector 108. The light reflecting film 109B is formed of e.g. a dielectric multilayer reflecting film having a structure obtained by alternately stacking a low refractive index thin film composed of SiO2 or the like and a high refractive index thin film composed of TiO2, Ta2O5, or the like to several layers. The light reflecting film 109B is deposited by PVD on the slope surface 109A of the reflector 108.

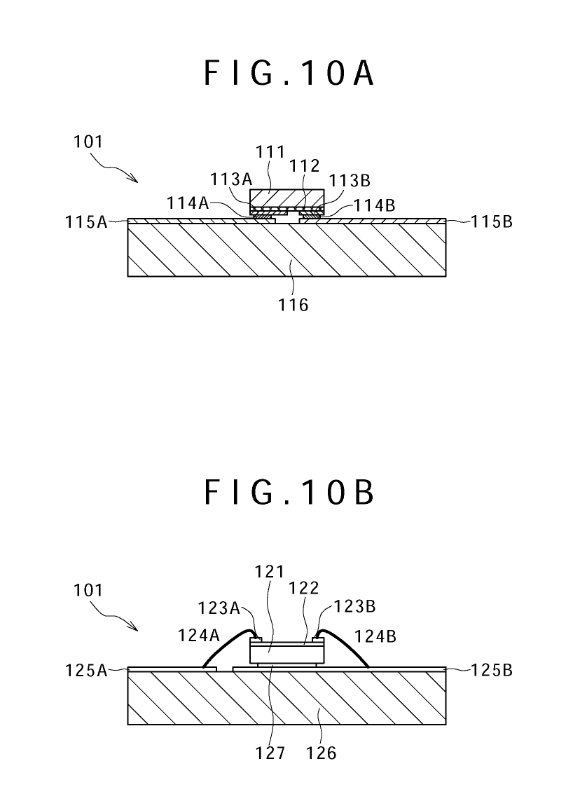

As shown in a schematic sectional view of FIG. 10A, the light emitting element 101 formed of a light emitting diode (LED) is composed of a base 111 and a light emitting layer 112 formed on the base 111. The light emitting layer 112 has a multilayer structure composed of a first compound semiconductor layer of a first conductivity type (e.g. n-type), an active layer formed on the first compound semiconductor layer, and a second compound semiconductor layer of a second conductivity type (e.g. p-type), formed on the active layer. Light from the light emitting layer passes through the base and is output to the external to enter the lens 102. That is, the structure shown in FIG. 10A is a so-called flip-chip structure.

A first electrode 113A is electrically connected to the first compound semiconductor layer and is connected to a first interconnect 115A provided on a submount 116 by a gold bump 114A. A second electrode 113B is electrically connected to the second compound semiconductor layer and is connected to a second interconnect 115B provided on the submount 116 by a gold bump 114B. The first interconnect 115A and the second interconnect 115B are connected to a light emitting element drive circuit (not shown) via the gold jumpers 106A and 106B and the interconnects 107A and 107B. The light emitting element 101 is driven by a pulse width modulation (PWM) signal or a constant current (CC) signal from this light emitting element drive circuit.

Alternatively, as shown in FIG. 10B, the light emitting element 101 is composed of a base 121 and a light emitting layer 122 formed on the base 121. The light emitting layer 122 has the same configuration and structure as those of the light emitting layer 112, and the base 121 has the same configuration and structure as those of the base 111. Light from the light emitting layer 122 enters the lens 102. That is, the structure shown in FIG. 10B is a so-called face-up structure. The base 121 is fixed to a submount 126 with the intermediary of a silver paste layer 127.

A first electrode 123A is electrically connected to the first compound semiconductor layer and is connected to a first interconnect 125A provided on the submount 126 by a gold jumper 124A. A second electrode 123B is electrically connected to the second compound semiconductor layer and is connected to a second interconnect 125B provided on the submount 126 by a gold jumper 124B. The first interconnect 125A and the second interconnect 125B are connected to a light emitting element drive circuit (not shown) via the gold jumpers 106A and 106B and the interconnects 107A and 107B. The light emitting element 101 is driven by a pulse width modulation (PWM) signal or a constant current (CC) signal from this light emitting element drive circuit.

The color liquid crystal display device 40 includes the display area 411 in which M₀ pixels are arranged along a first direction and N₀ pixels are arranged along a second direction perpendicular to the first direction, i.e. total M₀×N₀ pixels are arranged in a two-dimensional matrix. Here it is assumed that the display area 411 is divided into P×Q virtual display area units 412 (P and Q are each an integer equal to or larger than two, and they may be the same value or may be different values and depend on the specification of the color liquid crystal display device 40). Each display area unit 412 is composed of plural pixels. Specifically, for example, the image displaying resolution of the display area 411 satisfies the HD-TV standard. If the number M₀×N₀ of pixels arranged in a two-dimensional matrix is represented as (M₀, N₀), the number of pixels in the display area 411 is e.g. (1920, 1080). The display area 411 (indicated by the long dashed short dashed line in FIG. 2) including the pixels arranged in a two-dimensional matrix is divided into P×Q virtual display area units 412 (the boundary thereof is indicated by the dotted line). The values of (P, Q) are e.g. (19, 12). However, the number of display area units 412 (and the number of surface light source units 712 to be described later) in FIG. 2 is different from these values for simplification of the diagram. Each display area unit 412 includes plural (M×N) pixels, and the number of pixels included in one display area unit 412 is e.g. about ten thousand. Each pixel is obtained by assembling plural sub-pixels that emit light beams of colors different from each other into one group. Specifically, each pixel is composed of three kinds of sub-pixels: a red light emitting sub-pixel (sub-pixel [R]), a green light emitting sub-pixel (sub-pixel [G]), and a blue light emitting sub-pixel (sub-pixel [B]). This color liquid crystal display device 40 is line-sequentially driven. Specifically, the color liquid crystal display device 40 has scan electrodes (extending along the first direction) and data electrodes (extending along the second direction) that intersect with each other in a matrix manner. The scan electrodes are selected and scanned by inputting a scan signal to the scan electrodes, and an image is displayed based on a data signal (signal based on a control signal) input to the data electrodes. Thereby, one screen is obtained.

As described above, the direct-lit surface light source device (backlight) 70 of a division driving system includes P×Q surface light source units 712 that are individually controlled regarding driving and correspond to P×Q virtual display area units 412 defined based on the assumption that the display area 411 of the color liquid crystal display device 40 is divided into P×Q display area units 412. Each surface light source unit 712 illuminates the display area unit 412 corresponding to the surface light source unit 712 by white light from the back side of the display area unit 412. The surface light source device 70 is located below the color liquid crystal display device 40 although the color liquid crystal display device 40 and the surface light source device 70 are shown separately from each other in FIG. 2. The light source is formed of the light emitting element (light emitting diode) 101 driven based on a pulse width modulation (PWM) control system. The luminance of the surface light source unit 712 is increased and decreased by control of increase and decrease in the duty ratio of the light emitting element (light emitting diode) 101 included in the surface light source unit 712 based on the pulse width modulation control.

As shown in FIG. 4, the surface light source device 70 is formed by using a case 71 including an outer frame 73 and an inner frame 74. Ends of the transmissive color liquid crystal display device 40 are so held as to be sandwiched by the outer frame 73 and the inner frame 74 with the intermediary of spacers 75A and 75B. A guide component 76 is disposed between the outer frame 73 and the inner frame 74, which provides a structure that prevents the shift of the color liquid crystal display device 40 sandwiched by the outer frame 73 and the inner frame 74. At upper part of the inside of the case 71, the light diffuser 81 is attached to the inner frame 74 with the intermediary of a spacer 75C and a bracket component 77. Over the light diffuser 81, an optical functional sheet group including a diffusion sheet 82, a prism sheet 83, and a polarization conversion sheet 84 is stacked.

At lower part of the inside of the case 71, a reflecting sheet 85 is provided. This reflecting sheet 85 is so disposed that the reflective surface thereof is opposed to the light diffuser 81 and is located at a position lower than that of the lower end of the lens 102. The reflecting sheet 85 is attached to a bottom surface 72A of the case 71 with the intermediary of an attachment component (not shown). The reflecting sheet 85 can be formed of a high reflection film having a structure obtained by sequentially stacking a silver reflecting film, a low refractive index film, and a high refractive index film over a sheet base. The reflecting sheet 85 reflects light output from the lens 102 and light reflected by a side surface 72B of the case 71. Based on this structure, red light, green light, and blue light emitted from the red light emitting element assembly 10 for emitting the red light, the green light emitting element assembly 20 for emitting the green light, and the blue light emitting element assembly 30 for emitting the blue light are mixed with each other, so that white light having high color purity can be obtained as illuminating light. This illuminating light passes through the optical functional sheet group including the light diffuser 81, the diffusion sheet 82, the prism sheet 83, and the polarization conversion sheet 84, and irradiates the color liquid crystal display device 40 from its back side.

As shown in the schematic partial sectional view of FIG. 5, the color liquid crystal display device 40 includes a front panel 50 having a transparent first electrode 54, a rear panel 60 having transparent second electrodes 64, and a liquid crystal material 41 interposed between the front panel 50 and the rear panel 60.

The front panel 50 includes e.g. a first substrate 51 formed of a glass substrate and a polarizing film 56 provided on the outside surface of the first substrate 51. On the inside surface of the first substrate 51, a color filter 52 covered by an overcoat layer 53 composed of an acrylic resin or an epoxy resin is provided. The transparent first electrode (referred to also as a common electrode and composed of e.g. ITO) 54 is formed on the overcoat layer 53, and an alignment film 55 is formed on the transparent first electrode 54. On the other hand, the rear panel 60 includes, specifically, e.g. a second substrate 61 formed of a glass substrate, switching elements (specifically, thin film transistors (TFTs)) 62 formed on the inside surface of the second substrate 61, the transparent second electrodes (referred to also as pixel electrodes and composed of e.g. ITO) 64 controlled by the switching elements 62 regarding the conductive/non-conductive state, and a polarizing film 66 provided on the outside surface of the second substrate 61. An alignment film 65 is formed over the entire surface including the transparent second electrodes 64. The front panel 50 and the rear panel 60 are joined to each other with the intermediary of a sealing material (not shown) on the peripheral part of these panels. The switching element 62 is not limited to the TFT, but it is also possible that it is formed of e.g. a MIM element. Reference numeral 67 indicates an insulating layer provided between the switching elements 62.

Known components and material can be used as various components and the liquid crystal material in the transmissive color liquid crystal display device, and therefore detailed description thereof is omitted.

In the first embodiment, as the surface light source device, a surface light source device of a division driving system (partial driving system) to be described later is employed.

As shown in FIGS. 2 and 3, the drive circuitry for driving the surface light source device 70 and the color liquid crystal display device 40 based on a drive signal from the external (display circuit) includes a surface light source device control circuit 450 and surface light source unit drive circuits 460 for carrying out ON/OFF control of the light emitting element 101 included in the surface light source device 70 based on a pulse width modulation control system, and a liquid crystal display device drive circuit 470.

The surface light source device control circuit 450 includes an arithmetic circuit 451 and a storage device (memory) 452. The surface light source unit drive circuit 460 includes an arithmetic circuit 461, a storage device (memory) 462, an LED drive circuit 463, a photodiode control circuit 464, switching elements 465 each formed of an FET, and a light emitting element drive power supply (constant current source) 466. Known circuits and so on can be employed as these circuits and so on included in the surface light source device control circuit 450 and the surface light source unit drive circuit 460. The liquid crystal display device drive circuit 470 for driving the color liquid crystal display device 40 includes known circuits such as a timing controller 471. The color liquid crystal display device 40 includes a gate driver, a source driver, and so on (not shown) for driving the switching elements each formed of a TFT included in a liquid crystal cell.

The light emission state of the light emitting element 101 in a certain image displaying frame is measured by a photodiode 424. The output from the photodiode 424 is input to the photodiode control circuit 464 and is converted into data (signal) of e.g. the luminance and chromaticity of the light emitting element 101 in the photodiode control circuit 464 and the arithmetic circuit 461. This data is sent to the LED drive circuit 463, so that the light emission state of the light emitting element 101 in the next image displaying frame is controlled. That is, a feedback mechanism is formed.

Downstream of the light emitting element 101, a resistor r for current detection is inserted in series to the light emitting element 101. The current flowing through the resistor r is converted into voltage, and the operation of the light emitting element drive power supply 466 is so controlled under control by the LED drive circuit 463 that the voltage drop across the resistor r becomes a predetermined value. Although only one light emitting element drive power supply (constant current source) 466 is shown in FIG. 3, the light emitting element drive power supplies 466 for driving the respective light emitting elements 101 are disposed in practice. Three surface light source units 712 are shown in FIG. 3. Although the illustration is so made that one light emitting element 101 is included in one surface light source unit 712 in FIG. 3, the number of light emitting elements 101 included in the surface light source unit 712 is three or four in practice.

The display area 411 including the pixels arranged in a two-dimensional matrix is divided into P×Q display area units. If this state is expressed based on “rows” and “columns,” it can be said that the display area 411 is divided into the display area units on Q rows×P columns. The display area unit 412 includes the plural (M×N) pixels. If this state is expressed based on “rows” and “columns,” it can be said that the display area unit 412 includes the pixels on N rows×M columns. Furthermore, the red light emitting sub-pixel (sub-pixel [R]), the green light emitting sub-pixel (sub-pixel [G]), and the blue light emitting sub-pixel (sub-pixel [B]) will be often referred to collectively as “sub-pixels [R, G, B].” A red light emitting sub-pixel control signal, a green light emitting sub-pixel control signal, and a blue light emitting sub-pixel control signal input to the sub-pixels [R, G, B] for control of the operation of the sub-pixels [R, G, B] (specifically, control of e.g. the light transmission (aperture ratio)) will be often referred to collectively as “control signals [R, G, B].” A red light emitting sub-pixel drive signal, a green light emitting sub-pixel drive signal, and a blue light emitting sub-pixel drive signal input from the external to the drive circuitry in order to drive the sub-pixels [R, G, B] included in the display area unit will be often referred to collectively as “drive signals [R, G, B].”

As described above, each pixel is obtained by assembling the following three kinds of sub-pixels into one group: the red light emitting sub-pixel (sub-pixel [R]), the green light emitting sub-pixel (sub-pixel [G]), and the blue light emitting sub-pixel (sub-pixel [B]). In the following description of the embodiment, control of the luminance of each of the sub-pixels [R, G, B] (grayscale control) is 8-bit control; the luminance control is carried out based on 2⁸ stages in the range of 0 to 255. Therefore, each of values sx_{R}, sx_{G}, and sx_{B} of the drive signals [R, G, B] input to the liquid crystal display device drive circuit 470 in order to drive a respective one of the sub-pixels [R, G, B] in each pixel included in each display area unit 412 takes a value corresponding to one of 2⁸ stages. Furthermore, the value PS of a pulse width modulation output signal for controlling the light emission time of each of the light emitting elements 101 included in each surface light source unit also takes a value corresponding to one of 2⁸ stages in the range of 0 to 255. However, the embodiment is not limited thereto. For example, it is also possible to employ e.g. 10-bit control and carry out the luminance control based on 2¹⁰ stages in the range of 0 to 1023. In this case, the representation by 8-bit numerals is quadrupled for example.

A control signal for controlling the light transmission Lt of each of the sub-pixels is supplied from the drive circuitry to each of the sub-pixels. Specifically, the control signals [R, G, B] that each control the light transmission Lt of a respective one of the sub-pixels [R, G, B] are each supplied from the liquid crystal display device drive circuit 470 to the respective one of the sub-pixels [R, G, B]. More specifically, the control signals [R, G, B] are produced from the input drive signals [R, G, B] in the liquid crystal display device drive circuit 470, and the control signals [R, G, B] are supplied (output) to the sub-pixels [R, G, B]. Light source luminance SY₂ as the luminance of the surface light source unit 712 is changed for every image displaying frame. Therefore, the control signals [R, G, B] have e.g. values SX_{R-corr}, SX_{G-corr}, and SX_{B-corr} resulting from correction (compensation) based on the change in the light source luminance SY₂ for the values obtained by raising the values sx_{R}, sx_{G}, and sx_{B} of the drive signals [R, G, B] to the power of 2.2. The control signals [R, G, B] are sent by a known method from the timing controller 471 in the liquid crystal display device drive circuit 470 to the gate driver and the source driver in the color liquid crystal display device 40. The switching elements included in the respective sub-pixels are driven based on the control signals [R, G, B] and the desired voltages are applied to the transparent first electrode 54 and the transparent second electrodes 64 of the liquid crystal cells. Thereby, the light transmission (aperture ratio) Lt of each sub-pixel is controlled. When the values SX_{R-corr}, SX_{G-corr}, and SX_{B-corr} of the control signals [R, G, B] are larger, the light transmission (aperture ratio) Lt of the sub-pixels [R, G, B] is higher and the luminance (displaying luminance sy) of the part of the display area corresponding to the sub-pixels [R, G, B] is higher. That is, an image formed by the light passing through the sub-pixels [R, G, B] (the image is normally one kind and in a dot manner) is brighter.

The control of the displaying luminance sy and the light source luminance SY₂ is carried out for every image displaying frame in image displaying of the color liquid crystal display device 40, for each display area unit, and for each surface light source unit. Furthermore, the operation of the color liquid crystal display device 40 and the operation of the surface light source device 70 in one image displaying frame are synchronized with each other. The number of pieces of image information sent to the drive circuitry as an electric signal per one second (images per second) is the frame frequency (frame rate), and an inverse of the frame frequency is the frame time (unit: seconds).

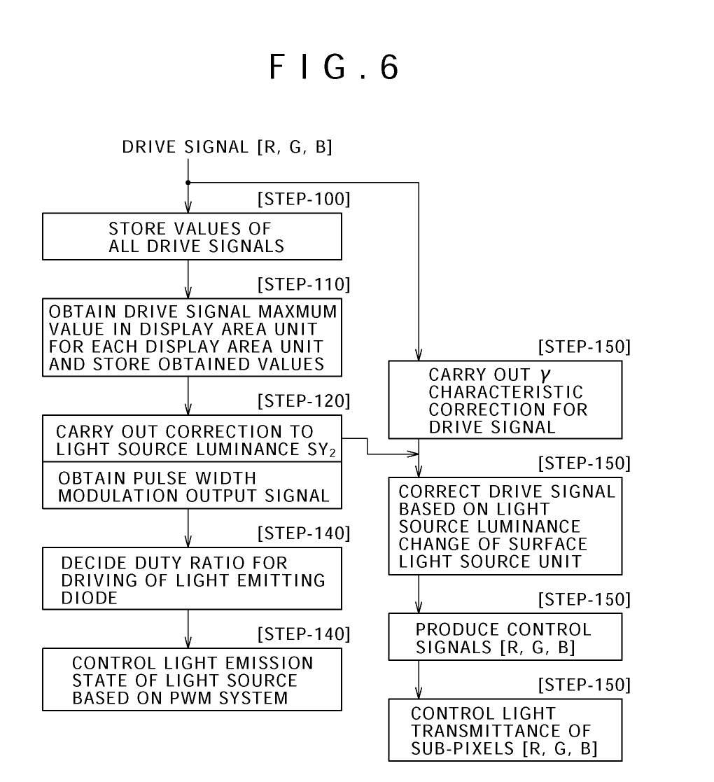

A method for driving the surface light source device of a division driving system will be described below with reference to FIGS. 2, 3, and 6. FIG. 6 is a flowchart for explaining the method for driving the surface light source device of the division driving system.

A control signal for controlling the light transmission Lt of each of the sub-pixels is supplied from the drive circuitry to each of the sub-pixels. Specifically, the control signals [R, G, B] that each control the light transmission Lt of a respective one of the sub-pixels [R, G, B] included in the pixel are each supplied from the liquid crystal display device drive circuit 470 to the respective one of the sub-pixels [R, G, B]. Furthermore, in order for each of the surface light source units 712 to provide the luminance (the second defined value sy₂ of the displaying luminance in response to the first defined value Lt₁ of the light transmission) of the pixel (sub-pixels [R, G, B]) obtained when it is assumed that the sub-pixels are supplied with the control signal corresponding to the drive signal having the value equal to the drive signal maximum value sx_{U-max} in the display area unit as the maximum value among the values sx_{R}, sx_{G}, and sx_{B} of the drive signals [R, G, B] input to the drive circuits 450, 460, and 470 in order to drive all of the pixels (sub-pixels [R, G, B]) included in the display area unit 412, the luminance of the light source included in the surface light source unit 712 corresponding to this display area unit 412 is controlled by the surface light source device control circuit 450 and the surface light source unit drive circuit 460. Specifically, for example, the light source luminance SY₂ is so controlled (e.g. decreased) that the displaying luminance sy₂ is obtained when the light transmission (aperture ratio) of the sub-pixel is set to the first defined value Lt₁ of the light transmission. That is, for example, the light source luminance SY₂ of the surface light source unit 712 is so controlled for every image displaying frame that the following equation (A) is satisfied. SY₂ and SY₁ satisfy the relationship SY₂≦SY₁.

SY₂·Lt₁=SY₁·Lt₂ (A)

[Step-100]

The drive signals [R, G, B] for one image displaying frame and a clock signal CLK sent from a known display circuit such as a scan converter are input to the surface light source device control circuit 450 and the liquid crystal display device drive circuit 470 (see FIG. 2). For example, the drive signals [R, G, B] are output signals from an image tube and are drive signals that are output from e.g. a broadcasting station and input also to the liquid crystal display device drive circuit 470 in order to control the light transmission Lt of the sub-pixels. If the amount of light input to the image tube is defined as sy′, the drive signals [R, G, B] can be represented by a function of the input light amount sy′ raised to the power of 0.45. The values sx_{R}, sx_{G}, and sx_{B} of the drive signals [R, G, B] of one image displaying frame input to the surface light source device control circuit 450 are temporarily stored in the storage device (memory) 452 included in the surface light source device control circuit 450. Furthermore, the values sx_{R}, sx_{G}, and sx_{B} of the drive signals [R, G, B] of one image displaying frame input to the liquid crystal display device drive circuit 470 are also temporarily stored in the storage device (not shown) included in the liquid crystal display device drive circuit 470.

[Step-110]

Subsequently, the arithmetic circuit 451 in the surface light source device control circuit 450 reads out the values of the drive signals [R, G, B] stored in the storage device 452. For the (p, q)-th (first, p=1, q=1) display area unit 412, the arithmetic circuit 451 obtains the drive signal maximum value sx_{U-max} in the display area unit as the maximum value among the values sx_{R}, sx_{G}, and sx_{B} of the drive signals [R, G, B] for driving the sub-pixels [R, G, B] in the pixel included in this (p, q)-th display area unit 412. The drive signal maximum value sx_{U-max} in the display area unit is stored in the storage device 452. This step is carried out for all of m=1, 2, . . . , M, n=1, 2, . . . , N, i.e. for M×N pixels.

For example, if sx_{R} is the value equivalent to “110,” sx_{G} is the value equivalent to “150,” and sx_{B} is the value equivalent to “50,” then sx_{U-max} is the value equivalent to “150.”

This operation is repeated for all of the display area units 412 from the (1, 1)-th display area unit 412 to the (P, Q)-th display area unit 412. The drive signal maximum values sx_{U-max} in all of the display area units 412 are stored in the storage device 452.

[Step-120]

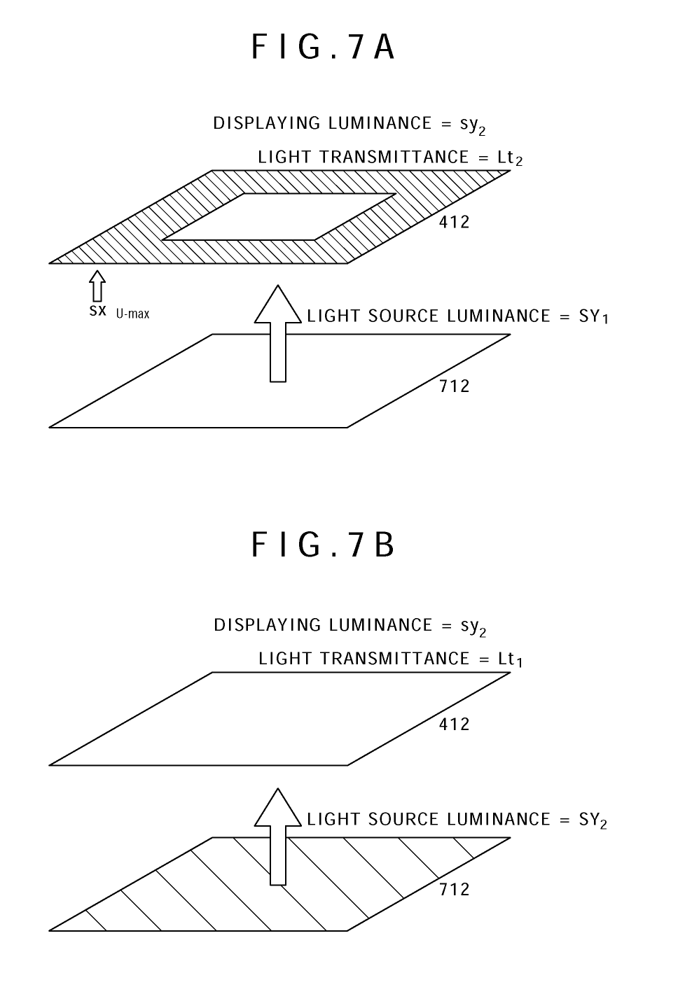

In order for the surface light source unit 712 to provide the luminance (the second defined value sy2 of the displaying luminance in response to the first defined value Lt1 of the light transmission) obtained when it is assumed that the sub-pixels [R, G, B] are supplied with the control signals [R, G, B] corresponding to the drive signals [R, G, B] having the value equal to the drive signal maximum value sx_{U-max} in the display area unit, the light source luminance SY₂ of the surface light source unit 712 corresponding to the display area unit 412 is increased/decreased under control by the surface light source unit drive circuit 460. Specifically, the light source luminance SY₂ is so controlled for every image displaying frame and for each surface light source unit that equation (A) shown below is satisfied. More specifically, the luminance of the light emitting element 101 is controlled based on equation (B) representing a light source luminance control function g(sxₙₒₗ₋ₘₐₓ), and the light source luminance SY₂ is so controlled that equation (A) is satisfied. A conceptual diagram of this control is shown in FIGS. 7A and 7B. However, as described later, it is desirable to carry out correction based on the influence of other surface light source units 712 for the light source luminance SY₂ according to need. The relationship among e.g. the following parameters relating to the control of the light source luminance SY₂ may be obtained in advance and stored in the storage device 452 or the like: the drive signal maximum value sx_{U-max} in the display area unit; the value of the control signal corresponding to the drive signal having the value equal to this maximum value sx_{U-max}; the second defined value sy₂ of the displaying luminance when such a control signal is supplied to the sub-pixel; the light transmission (aperture ratio) of each sub-pixel at the time (the second defined value Lt₂ of the light transmission); such a luminance control parameter in the surface light source unit 712 that the second defined value sy₂ of the displaying luminance is obtained when the light transmission (aperture ratio) of each sub-pixel is set to the first defined value Lt₁ of the light transmission.

SY₂·Lt₁=SY₁·Lt₂ (A)

g(sxₙₒₗ₋ₘₐₓ)=a₁(sxₙₒₗ₋ₘₐₓ)^{2.2}+a₀ (B)

If the maximum value of the drive signals (drive signals [R, G, B]) input to the liquid crystal display device drive circuit 470 in order to drive the sub-pixels [R, G, B] included in the pixel is defined as sxₘₐₓ, the following relationship is satisfied.

sxₙₒₗ₋ₘₐₓ≡sx_{U-max}/sxₘₐₓ

a₁ and a₀ are constants and can be represented by the following formulas.

a₁+a₀=1

0≦a₀<1, 0<a₁<1

For example, a₁ and a₀ are set as follows.

a₁=0.99

a₀=0.01

Because each of the values sx_{R}, sx_{G}, and sx_{B} of the drive signals [R, G, B] takes a value corresponding to one of 2⁸ stages, the value sxₘₐₓ corresponds to “255.”

By the way, for the surface light source device 70, when the luminance control of the (1, 1)-th surface light source unit 712 is assumed for example, the influence of the other P×Q surface light source units 712 needs to be taken into consideration in some cases. The influence on the surface light source unit 712 from the other surface light source units 712 is known in advance due to the light emission profiles of the respective surface light source units 712. Therefore, the difference can be calculated by inverse calculation. As a result, correction is possible. The basic form of the arithmetic operation will be described below.

The luminance (the light source luminance SY₂) required for P×Q surface light source units 712 based on the demands of equation (A) and equation (B) is represented by a matrix [L_{P×Q}]. The luminance of the surface light source unit obtained when only this surface light source unit is driven whereas the other surface light source units are not driven is obtained in advance for each of P×Q surface light source units 712. This luminance is represented by a matrix [L′_{P×Q}]. Furthermore, a correction coefficient is represented by a matrix [α_{P×Q}]. The relationship among these matrices can be represented by the following equation (C-1). The matrix [α_{P×Q}] of the correction coefficient can be obtained in advance.

[L_{P×Q}]=[L′_{P×Q}]·[α_{P×Q}] (C-1)

Therefore, the matrix [L′_{P×Q}] is obtained from equation (C-1). The matrix [L′_{P×Q}] can be obtained by arithmetic operation of an inverse matrix. That is, the following equation is calculated.

[L′_{P×Q}]=[L_{P×Q}]·[α_{P×Q}]⁻¹ (C-2)

Furthermore, the light source (the light emitting element 101) included in each surface light source unit 712 is so controlled that the luminance represented by the matrix [L′_{P×Q}] is obtained. Specifically, this operation and processing are carried out by using the information (data table) stored in the storage device (memory) 462. It is obvious that the arithmetic operation result needs to be confined in the positive region in the control of the light emitting element 101, because it is impossible for the values of the matrix [L′_{P×Q}] to take a negative value. Therefore, the solution of equation (C-2) is often not an exact solution but an approximate solution.

In this way, based on the matrix [L_{P×Q}] obtained based on the values of equation (A) and equation (B) obtained in the arithmetic circuit 451 included in the surface light source device control circuit 450 and the correction coefficient matrix [α_{P×Q}], the matrix [L′_{P×Q}] of the luminance obtained when it is assumed that the surface light source unit is solely driven is obtained as described above. Furthermore, the obtained matrix is converted into the corresponding integers in the range of 0 to 255 (the values of the pulse width modulation output signal) based on a conversion table stored in the storage device 452. In this manner, a value PS of a pulse width modulation output signal for controlling the light emission time of the light emitting element 101 in the surface light source unit 712 can be obtained in the arithmetic circuit 451 included in the surface light source device control circuit 450.

[Step-130]

Subsequently, the value PS of the pulse width modulation output signal obtained in the arithmetic circuit 451 included in the surface light source device control circuit 450 is sent to the storage device 462 in the surface light source unit drive circuit 460 provided corresponding to the surface light source unit 712 and is stored in the storage device 462. Furthermore, the clock signal CLK is also sent to the surface light source unit drive circuit 460 (see FIG. 3).

[Step-140]

Based on the value PS of the pulse width modulation output signal, the arithmetic circuit 461 decides the on-time t_{ON} and the off-time t_{OFF} of the light emitting element 101 included in the surface light source unit 712. t_{ON} and t_{OFF} satisfy the following relationship.

t_{ON}+t_{OFF}=constant value t_{Const}

The duty ratio of the light emitting element in the driving thereof based on the pulse width modulation can be expressed by the following equation.

t_{ON}/(t_{ON}+t_{OFF})=t_{ON}/t_{Const}

The signal corresponding to the on-time t_{ON} of the light emitting element 101 included in the surface light source unit 712 is sent to the LED drive circuit 463. Based on the value of this signal corresponding to the on-time t_{ON} from the LED drive circuit 463, the switching element 465 is set to the on-state for only the on-time t_{ON}, so that an LED drive current from the light emitting element drive power supply 466 is applied to the light emitting element 101. As a result, each light emitting element 101 emits light for only the on-time t_{ON} in one image displaying frame. In this manner, each display area unit 412 is illuminated with predetermined illuminance.

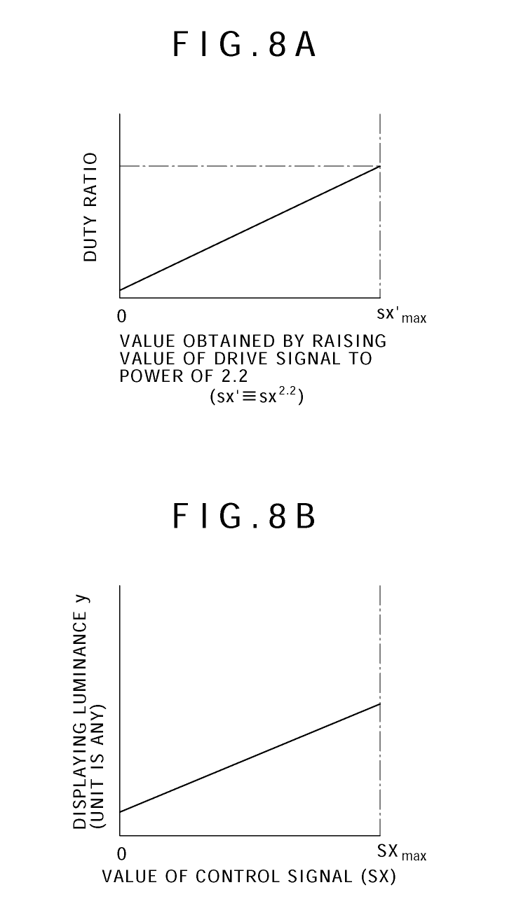

The thus obtained state is shown by the solid lines in FIGS. 8A and 8B. FIG. 8A is a diagram schematically showing the relationship between the duty ratio (=t_{ON}/t_{Const}) and the value obtained by raising the value of the drive signal input to the liquid crystal display device drive circuit 470 in order to drive the sub-pixel to the power of 2.2 (sx′=sx^{2.2}). FIG. 8B is a diagram schematically showing the relationship between the displaying luminance sy and the value SX of the control signal for controlling the light transmission Lt of the sub-pixel.

[Step-150]

On the other hand, the values sx_{R}, sx_{G}, and sx_{B} of the drive signals [R, G, B] input to the liquid crystal display device drive circuit 470 are sent to the timing controller 471. The timing controller 471 supplies (outputs) the control signals [R, G, B] corresponding to the input drive signals [R, G, B] to the sub-pixels [R, G, B]. The values SX_{R}, SX_{G}, and SX_{B} of the control signals [R, G, B], which are produced in the timing controller 471 in the liquid crystal display device drive circuit 470 and supplied from the liquid crystal display device drive circuit 470 to the sub-pixels [R, G, B], and the values sx_{R}, sx_{G}, and sx_{B} of the drive signals [R, G, B] have the relationships represented by equation (D-1), equation (D-2), and equation (D-3) shown below. In these equations, b₁_{_{—}}_{R}, b₀_{_{—}}_{R}, b₁_{_{—}}_{G}, b₀_{_{—}}_{G}, b₁_{_{—}}_{B}, and b₀_{_{—}}_{B} are constants. The light source luminance SY₂ of the surface light source unit 712 is changed for every image displaying frame. Therefore, basically the control signals [R, G, B] have the values resulting from correction (compensation) based on the change in the light source luminance SY₂ for the values obtained by raising the values of the drive signals [R, G, B] to the power of 2.2. Specifically, because the light source luminance SY₂ is changed for every image displaying frame, the values SX_{R}, SX_{G}, and SX_{B} of the control signals [R, G, B] are so decided and corrected (compensated) that the second defined value sy₂ of the displaying luminance is obtained in response to the light source luminance SY₂ (≦SY₁), to thereby control the light transmission (aperture ratio) Lt of the pixel or the sub-pixel. Functions f_{R}, f_{G}, and f_{B} in equation (D-1), equation (D-2), and equation (D-3) are used for this correction (compensation) and obtained in advance.

SX_{R}=f_{R}(b₁_{_{—}}_{R}·sx_{R}^{2.2}+b₀_{_{—}}_{R}) (D-1)

SX_{G}=f_{G}(b₁_{_{—}}_{G}·sx_{G}^{2.2}+b₀_{_{—}}_{G}) (D-2)

SX_{B}=f_{B}(b₁_{_{—}}_{B}·sx_{B}^{2.2}+b₀_{_{—}}_{B}) (D-3)

In this manner, the image displaying operation for one image displaying frame is completed.

### Second Embodiment

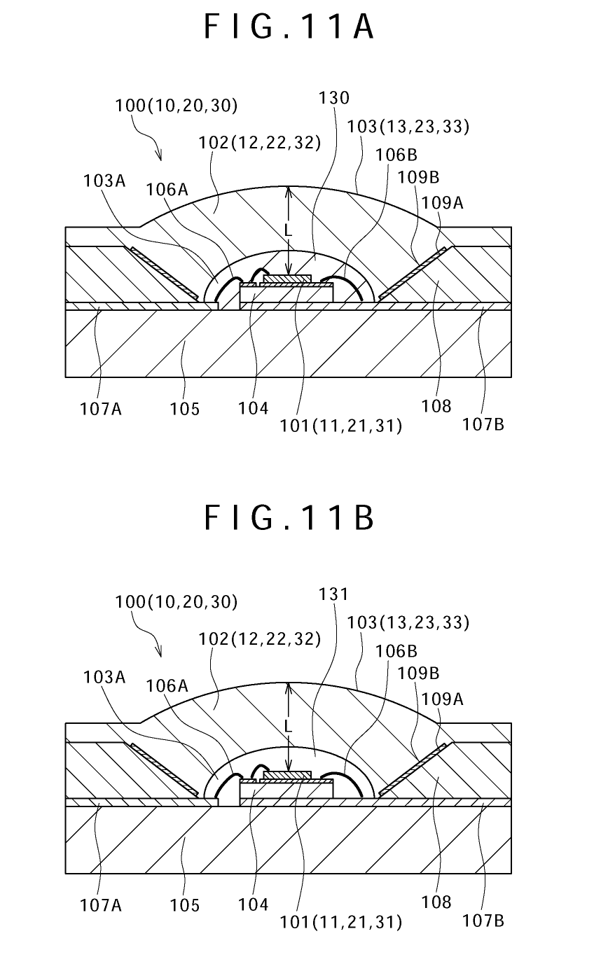

A second embodiment of the present invention is a modification of the first embodiment. In the first embodiment, the light emitting element 101 is covered by the lens 102 with the intermediary of no gap therebetween. On the other hand, in the second embodiment, as shown in a schematic sectional view of FIG. 11A, the light emitting element 101 is opposed to the lens 102 with the intermediary of a light transmissive medium layer 130. Specifically, a recess 103A provided under the lower surface of the lens 102 is filled with the light transmissive medium layer 130. The light transmissive medium layer 130 is composed of a gel silicone resin (refractive index: 1.41), and the lens 102 is composed of a polycarbonate resin having a refractive index of 1.59. Except for the above-described features, the same configurations and structures as those of the lens 102 and the light emitting element assembly 100 in the first embodiment can be employed as the configurations and structures of the lens 102 and the light emitting element assembly 100 in the second embodiment. Therefore, detailed description thereof is omitted.

Alternatively, it is also possible to employ configuration and structure shown in FIG. 11B. Specifically, an air layer 131 exists between the lens 102 and the light emitting element 101. The recess 103A is provided under the lower surface of the lens 102, and the light emitting element 101 is disposed in this recess 103A.

The lens 102 (composed of e.g. a plastic material) can be molded based on not only transfer molding but also e.g. injection molding. Specifically, a melted resin is injected into a mold for injection molding and the resin is solidified. Thereafter, the lens 102 is brought out from the mold through mold opening. The lens 102 has a simple shape and can be easily brought out from the mold. Therefore, it has high productivity and mass productivity. Furthermore, in the manufacturing thereof, the possibility of the occurrence of variation in the shape is extremely low, and a defect (crack) also hardly occurs. If a flange part (not shown) is formed at the side surface end that does not contribute to light extraction, the lens can be brought out from the mold more easily and the attachment of the lens to the surface light source device in the light emitting element assembly also becomes easier. After the lens is obtained, for example, an adhesive (serving also as the light transmissive medium layer for example) composed of an epoxy resin that is transparent to light emitted from the light emitting element is applied on the recess 103A of the lens 102 or the base 111, 121 of the light emitting element 101. Subsequently, the adhesive is cured while the lens 102 is disposed above the base 111, 121 and the lens 102 and the base 111, 121 are brought into tight contact with each other optically. Thereby, the light emitting element 101 can be fixed to the lens 102. The size of the light emitting element 101 is sufficiently smaller than that of the submount 116, 126. Therefore, if only the light emitting element 101 is fixed to the lens 102, the distortion of the lens 102 due to heat generated at the time of the operation of the light emitting element 101 can be reduced, which allows achievement of the designed performance as the light extraction performance.

Preferred embodiments of the present invention have been described above. The present invention however is not limited to these embodiments. The shapes, configurations, structures, materials, and so on of the lens (light extraction lens) and the light emitting element assembly described in the embodiments are examples and can be accordingly changed. In addition, the configurations and structures of the surface light source device and the liquid crystal display device assembly are also examples and can be accordingly changed. Although the surface light source device of a partial driving system or a division driving system is employed in the embodiments, it is also possible to employ a surface light source device that illuminates the entire display area with uniform, constant luminance. In addition, although the liquid crystal display device of a color filter system is employed in the embodiments, it is also possible to employ a liquid crystal display device of a so-called field sequential system.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A surface light source device that illuminates a transmissive liquid crystal display device having a display area formed of pixels arranged in a two-dimensional matrix from a back side of the liquid crystal display device, the surface light source device comprising
a plurality of light emitting element units, wherein
each of the light emitting element units includes:
(A) at least one first light emitting element assembly that is formed of a first light emitting element and a first lens and emits, via the first lens, first primary color light corresponding to a first primary color of three primary colors of light, composed of the first primary color, a second primary color, and a third primary color;
(B) at least one second light emitting element assembly that is formed of a second light emitting element and a second lens and emits second primary color light corresponding to the second primary color via the second lens; and
(C) at least one third light emitting element assembly that is formed of a third light emitting element and a third lens and emits third primary color light corresponding to the third primary color via the third lens, and
focal length and lateral magnification of each of the first lens, the second lens, and the third lens are adjusted based on emission intensity distribution of each of the first light emitting element, the second light emitting element, and the third light emitting element.

2. The surface light source device according to claim 1, wherein
P×Q surface light source units are provided that are independently controlled regarding driving and correspond to P×Q virtual display area units defined based on an assumption that the display area of the liquid crystal display device is divided into the P×Q display area units, and
each of the surface light source units includes at least one light emitting element unit.

3. The surface light source device according to claim 1, wherein a light diffuser is disposed above the plurality of light emitting element units.

4. The surface light source device according to claim 1, wherein
the first lens is disposed on the first light emitting element with intermediary of no gap,
the second lens is disposed on the second light emitting element with intermediary of no gap, and
the third lens is disposed on the third light emitting element with intermediary of no gap.

5. The surface light source device according to claim 1, wherein each of the light emitting element units includes:
one first light emitting element assembly that emits red light;
two second light emitting element assemblies that emit green light; and
one third light emitting element assembly that emits blue light.

6. A surface light source device that illuminates a transmissive liquid crystal display device having a display area formed of pixels arranged in a two-dimensional matrix from a back side of the liquid crystal display device, the surface light source device comprising
P×Q surface light source units configured to be independently controlled regarding driving and correspond to P×Q virtual display area units defined based on an assumption that the display area of the liquid crystal display device is divided into the P×Q display area units, wherein
a light diffuser is disposed above the P×Q surface light source units,
each of the surface light source units includes at least one light emitting element unit,
each light emitting element unit includes:
(A) at least one first light emitting element assembly that is formed of a first light emitting element and a first lens and emits, via the first lens, first primary color light corresponding to a first primary color of three primary colors of light, composed of the first primary color, a second primary color, and a third primary color;
(B) at least one second light emitting element assembly that is formed of a second light emitting element and a second lens and emits second primary color light corresponding to the second primary color via the second lens; and
(C) at least one third light emitting element assembly that is formed of a third light emitting element and a third lens and emits third primary color light corresponding to the third primary color via the third lens, and
focal length of each of the first lens, the second lens, and the third lens is adjusted based on light intensity distributions on the light diffuser, of light beams emitted from the first light emitting element, the second light emitting element, and the third light emitting element.

7. The surface light source device according to claim 6, wherein
the light intensity distributions on the light diffuser, of light beams emitted from the first light emitting element, the second light emitting element, and the third light emitting element are compared with desired light intensity distributions on the light diffuser, and the focal length of each of the first lens, the second lens, and the third lens is so adjusted that difference, obtained as a result of the comparison, between the desired light intensity distributions and the light intensity distributions on the light diffuser, of the light beams emitted from the first light emitting element, the second light emitting element, and the third light emitting element becomes minimum.

8. The surface light source device according to claim 6, wherein
the first lens is disposed on the first light emitting element with intermediary of no gap,
the second lens is disposed on the second light emitting element with intermediary of no gap, and
the third lens is disposed on the third light emitting element with intermediary of no gap.

9. The surface light source device according to claim 6, wherein each light emitting element unit includes:
one first light emitting element assembly that emits red light;
two second light emitting element assemblies that emit green light; and
one third light emitting element assembly that emits blue light.

10. A liquid crystal display device assembly comprising:
(1) a transmissive liquid crystal display device configured to have a display area formed of pixels arranged in a two-dimensional matrix; and
(2) a surface light source device configured to illuminate the liquid crystal display device from a back side of the liquid crystal display device, wherein
the surface light source device includes a plurality of light emitting element units,
each of the light emitting element units includes:
(A) at least one first light emitting element assembly that is formed of a first light emitting element and a first lens and emits, via the first lens, first primary color light corresponding to a first primary color of three primary colors of light, composed of the first primary color, a second primary color, and a third primary color;
(B) at least one second light emitting element assembly that is formed of a second light emitting element and a second lens and emits second primary color light corresponding to the second primary color via the second lens; and
(C) at least one third light emitting element assembly that is formed of a third light emitting element and a third lens and emits third primary color light corresponding to the third primary color via the third lens, and
focal length and lateral magnification of each of the first lens, the second lens, and the third lens are adjusted based on emission intensity distribution of each of the first light emitting element, the second light emitting element, and the third light emitting element.

11. A liquid crystal display device assembly comprising:
(1) a transmissive liquid crystal display device configured to have a display area formed of pixels arranged in a two-dimensional matrix; and
(2) a surface light source device configured to illuminate the liquid crystal display device from a back side of the liquid crystal display device, wherein
the surface light source device includes P×Q surface light source units that are independently controlled regarding driving and correspond to P×Q virtual display area units defined based on an assumption that the display area of the liquid crystal display device is divided into the P×Q display area units, and
a light diffuser is disposed above the P×Q surface light source units,
each of the surface light source units includes at least one light emitting element unit,
each light emitting element unit includes:
(A) at least one first light emitting element assembly that is formed of a first light emitting element and a first lens and emits, via the first lens, first primary color light corresponding to a first primary color of three primary colors of light, composed of the first primary color, a second primary color, and a third primary color;
(B) at least one second light emitting element assembly that is formed of a second light emitting element and a second lens and emits second primary color light corresponding to the second primary color via the second lens; and
(C) at least one third light emitting element assembly that is formed of a third light emitting element and a third lens and emits third primary color light corresponding to the third primary color via the third lens, and
focal length of each of the first lens, the second lens, and the third lens is adjusted based on light intensity distributions on the light diffuser, of light beams emitted from the first light emitting element, the second light emitting element, and the third light emitting element.
